(19) United States
(12) Patent Application Publication
(10) Pub. No.: US 2026/0233646 A1
(43) Pub. Date: Aug. 13, 2026

(54) CHILD SAFETY SEAT

(71) Applicant: WONDERLAND SWITZERLAND AG, Steinhausen (CH)

(72) Inventors: Daliang ZHANG, Dongguan, Guangdong (CN); Ganqing FANG, Dongguan, Guangdong (CN)

(73) Assignee: WONDERLAND SWITZERLAND AG, Steinhausen (CH)

(21) Appl. No.: 19/157,988

(22) PCT Filed: Feb. 20, 2024
(86) PCT No.: PCT/EP2024/054292

§ 371 Date: Aug. 19, 2025

(30) Foreign Application Priority Data
Feb. 20, 2023 (CN) 2023101424166
Feb. 20, 2023 (CN) 2023101424325
Mar. 6, 2023 (CN) 2023102079712
Feb. 7, 2024 (CN) 2024101761022

(51) Int. Cl. B60N 2/28; B60N 2/26; B60N 2/56

(52) U.S. Cl. CPC B60N 2/2851; B60N 2/269; B60N 2/2818; B60N 2/2872; B60N 2/2875; B60N 2/2887; B60N 2/5664

(57) ABSTRACT

The present disclosure discloses a child safety seat. The child safety seat includes a seat body, a fixing assembly, and an indicating assembly. The indicating assembly is disposed on the seat body and comprises an indicating element, and the indicating element is linked with the fixing assembly, so that when the fixing assembly is unlocked, indicating element is held in a first position, and when the fixing assembly is locked, the indicating element is held in a second position. The child safety seat and the indicating assembly provided by the present disclosure can conveniently remind a user of a state of the fixing assembly.

### CROSS-REFERENCE TO RELATED APPLICATIONS

This application is a U.S. National Stage Application of PCT/EP2024/054292, filed on Feb. 20, 2024, which claims the benefit of Chinese Application No. 202310142416.6, filed on Feb. 20, 2023, Chinese Application No. 202310142432.5, filed on Feb. 20, 2023, Chinese Application No. 202310207971.2, filed on Mar. 6, 2023, and Chinese Application No. 202410176102.2, filed on Feb. 7, 2024, all of which are incorporated herein by reference in their entirety.

### TECHNICAL FIELD

The present disclosure relates to the technical field of child safety seats, and in particular to a child safety seat capable of indicating a state and a child safety seat with a headrest height adjusting structure and a shoulder belt adjusting structure.

### BACKGROUND

A child safety seat is generally provided with a fixing assembly for fixing the child safety seat to a seat of a vehicle. The fixing assembly may be an ISOFIX. The child safety seat may be installed on the seat of the vehicle through the ISOFIX, which makes the installation convenient. In addition, in order to remind the user to install the ISOFIX correctly, the child safety seat may be provided with an indicating structure to indicate locking and unlocking of the ISOFIX. Consumers may know the installation status of the ISOFIX through such indicating structure. The existing child safety seat usually sets the indicating structure on the ISOFIX, but the position of such indicating structure is close to a riding surface of the seat of the vehicle. If an object is placed on the seat of the vehicle, the indicating structure may be shielded and cannot be directly observed. Therefore, the indication structure of the existing child safety seat is inconvenient to use.

The child safety seat usually uses two ways to fix a child sitting on it, that is, when the child safety seat is used by a child with a relatively small size or height, the child is fixed by a five-point safety belt disposed on the child safety seat, and when the child safety seat is used by a child with a relatively large size or height, the child is fixed by a vehicle safety belt. In order to adapt to the use of children with different size and heights, the child safety seat is usually provided with a headrest with an adjustable height, and in order to facilitate the adjustment of the shoulder belt, the height adjustment of the headrest usually drives the height adjustment of the shoulder belt. In this case, as the headrest is adjusted to a relatively high position, the shoulder belt of the five-point safety belt will also rise, which will lead to a misuse of the fixing method, that is, the five-point safety belt is used for the child with the relatively large size or height, resulting in uncomfortable user experience.

The existing child safety seat generally includes a seat body and seat cover sleeved on the seat body. The seat body itself usually has poor air permeability, and the seat cover will further reduce the air permeability of the seat. At present, some child safety seats are provided with vents on the seat body and the seat cover is made of air-permeable cloth, so as to improve the air permeability of the child safety seats. However, due to an unreasonable layout of the vents, there is still a problem of poor air permeability.

Therefore, there is a need to further improve an arrangement of vents to provide good air permeability.

The child safety seat usually uses the five-point safety belt, that is, two shoulder belts, two waist belts and a crotch belt are connected to a waist buckle from each edge of the seat. In this case, it is necessary to use buckles including a male buckle and a female buckle. In order to facilitate the storage of the buckle and improve the aesthetics, it is necessary to set a buckle storage structure on the child safety seat.

The backrest portion of the child safety seat may be disposed to be detachably connected to the seat portion. In this case, it is necessary to provide a backrest locking structure, so that the backrest portion can be connected to or separated from the seat portion conveniently and stably.

The seat portion of the child safety seat can be set to adjust a pitch angle, that is, an angle of the plane of the seat portion relative to a bearing surface (horizontal plane) can be adjusted. In this case, it is necessary to provide a simple and reliable seat angle adjusting structure.

### SUMMARY

The present disclosure provides a child safety seat including a seat body, a fixing assembly and an indicating assembly, wherein the indicating assembly is disposed on the seat body and includes an indicating element, and the indicating element is linked with the fixing assembly, so that when the fixing assembly is unlocked, the indicating element is held in a first position, and when the fixing assembly is locked, the indicating element is held in a second position.

The present disclosure provides a child safety seat including a seat body and an ISOFIX, wherein an indicating assembly is disposed on the seat body, and the indicating assembly includes an indicating element, and the indicating element is linked with the ISOFIX, so that a locking and an unlocking of the ISOFIX can be indicated.

The present disclosure provides an indicating assembly including an operating element, a linkage element and an indicating element, wherein the operating element can be actuated to move the indicating element from one of a first position and a second position to the other of the first position and the second position, and wherein the operating element is linked with a fixing assembly via the linkage element so that the operating element can be actuated to lock or unlock the fixing assembly.

The present disclosure provides a child safety seat. The child safety seat includes a headrest and a backrest. The headrest is provided with a hole for a safety belt to pass through. The headrest is slidably connected to the backrest and can be adjusted to different positions relative to the backrest. The backrest is provided with a first turning portion, which is disposed at a non-top position of the backrest, and the safety belt bypasses the first turning portion and extends out from a front side of the child safety seat through the hole. When the hole is lower than the first turning portion, a position of the headrest can be adjusted freely. Otherwise, the safety belt passing through the hole will limit the headrest from further upward adjustment relative to the backrest.

### BRIEF DESCRIPTION OF THE DRAWINGS

Various objects, features and advantages of the present disclosure will become more apparent by considering the following detailed description of preferred embodiments of the present disclosure in conjunction with the accompanying drawings. The drawings are only exemplary illustrations of the present disclosure and are not necessarily drawn to scale. In the drawings, the same reference numerals refer to the same or similar parts throughout. In the drawings:

FIG. 1 is a perspective view of a child safety seat of the present disclosure, in which an operating element is not actuated;

FIG. 2 is a partial enlarged view of FIG. 1;

FIG. 3 is a perspective view of the child safety seat of the present disclosure, in which the operating element is actuated;

FIG. 4 is a partial enlarged view of FIG. 3;

FIG. 5 is a perspective view of the child safety seat of the present disclosure, in which a part of the child safety seat is removed to show an internal structure, and an indicating element is at a position where a first indicating portion is exposed from an indicating window;

FIG. 6 is a partial enlarged view of FIG. 5;

FIG. 7 is a perspective view of the child safety seat of the present disclosure, in which a part of the child safety seat is removed to show the internal structure, and the indicating element is at a position where a second indicating portion is exposed from the indicating window;

FIG. 8 is a partial enlarged view of FIG. 7;

FIG. 9 is a cross-sectional view of a fixing assembly of the child safety seat of the present disclosure, in which the fixing assembly is in a locking position;

FIG. 10 is a cross-sectional view of the fixing assembly of the child safety seat of the present disclosure, in which the fixing assembly is in an unlocking position;

FIG. 11 is an exploded perspective view of the child safety seat of the present disclosure;

FIG. 12 is a perspective view of a part of components of the child safety seat of the present disclosure, in which two fixing assemblies are fixed together by a linkage rod;

FIG. 13 is an exploded perspective view of a part of components of the child safety seat of the present disclosure;

FIG. 14 is a bottom perspective view of the child safety seat of the present disclosure;

FIG. 15 is a perspective view of a base of the child safety seat of the present disclosure, in which a part of the base is removed to show an internal structure;

FIG. 16 is a partial enlarged view of FIG. 15;

FIG. 17 is a top view of the base of the child safety seat of the present disclosure, in which a part of the base is removed to show the internal structure;

FIG. 18 is a partial enlarged view of FIG. 17;

FIG. 19 is a partial cross-sectional view of the base of the child safety seat of the present disclosure, in which the fixing assembly is in an extended position; and

FIG. 20 is a partial enlarged view of FIG. 19;

FIG. 21 is a partial cross-sectional view of the base of the child safety seat of the present disclosure, in which the fixing assembly is in a retracted position;

FIG. 22 shows a front perspective view of a child safety seat according to the present disclosure, in which a headrest is in a first position;

FIG. 23 shows another state of the child safety seat shown in FIG. 22, in which the headrest is in a second position;

FIG. 24 shows a rear view of the child safety seat shown in FIG. 23;

FIG. 25 shows a rear perspective view of the child safety seat shown in FIG. 22;

FIG. 26 shows a sectional side view of the child safety seat shown in FIG. 22;

FIG. 27 shows a sectional side view of the headrest of the child safety seat shown in FIG. 26 in another position;

FIG. 28 is an appearance schematic diagram showing the headrest of the child safety seat shown in FIG. 26 sleeved with a headrest covering cloth;

FIGS. 29 and 30 show front perspective views of the child safety seats shown in FIGS. 26 and 27, respectively, in which a use of a safety belt is schematically shown;

FIG. 31 shows a rear view of the child safety seat shown in FIG. 30;

FIG. 32 shows a perspective view of the headrest of the child safety seat according to the present disclosure;

FIG. 33 shows another perspective view of the headrest shown in FIG. 32, in which a connecting plate of the headrest is removed;

FIG. 34 shows a perspective view of the child safety seat according to the present disclosure with the headrest being removed;

FIGS. 35 and 36 respectively show a working principle of a headrest height adjusting structure of the present disclosure;

FIG. 37 is a perspective view of the child safety seat according to the present disclosure;

FIG. 38 is a perspective view of the child safety seat according to the present disclosure from another view;

FIG. 39 is an exploded perspective view of a backrest portion of the child safety seat according to the present disclosure;

FIG. 40 is a front view of a headrest portion of the child safety seat according to the present disclosure;

FIG. 41 is a perspective view of the headrest portion of the child safety seat according to the present disclosure;

FIG. 42 is a perspective view from another view of the headrest portion of the child safety seat according to the present disclosure;

FIG. 43 is a perspective view of the child safety seat according to the present disclosure, in which the headrest portion is removed;

FIG. 44 is a front view of the backrest portion of the child safety seat according to the present disclosure;

FIG. 45 is a perspective view from a back view of the child safety seat according to the present disclosure;

FIG. 46 is a front view of the child safety seat according to the present disclosure, in which the headrest portion is in a lowest position;

FIG. 47 is a front view of the child safety seat according to the present disclosure, in which the headrest portion is in a middle position;

FIG. 48A is a front view of the child safety seat according to the present disclosure, in which the headrest portion is in another middle position;

FIG. 48B is a partial enlarged view of a part enclosed by a circle in FIG. 48A;

FIG. 49 is a front view of the child safety seat according to the present disclosure, in which the headrest portion is in a highest position;

FIG. 50 is a perspective view of the child safety seat according to the present disclosure, in which a buckle storage structure is shown;

FIG. 51 is a perspective view from another view of the child safety seat according to the present disclosure, in which the buckle storage structure is shown;

FIG. 52 is a side cross-sectional view of the child safety seat according to the present disclosure, in which a backrest locking structure is shown;

FIG. 53 is a partial enlarged view of a part enclosed by a block in FIG. 52;

FIG. 54 is a perspective view of the backrest portion of the child safety seat according to the present disclosure, in which the backrest locking structure is shown;

FIG. 55 is a partial enlarged view of a part enclosed by a block in FIG. 54;

FIG. 56 is a perspective view of a seat portion of the child safety seat according to the present disclosure, in which a locking groove is shown;

FIG. 57 is a side view of the child safety seat according to the present disclosure, in which a seat angle adjusting structure is shown;

FIG. 58 is a perspective view of a bottom view of the seat portion of the child safety seat according to the present disclosure, in which a supporting element is in an unfolded position;

FIG. 59 is a perspective view of the bottom view of the seat portion of the child safety seat according to the present disclosure, in which the supporting element is in a folded position; and

FIG. 60 is an exploded perspective view of the bottom view of the seat portion of the child safety seat according to the present disclosure.

### LIST OF REFERENCE NUMERALS

1 child safety seat
10 seat body
110 backrest
120 base
121 indicating window
122 sliding groove
123 base upper cover
124 transparent component
125 fixing block
126 U-shaped element
127 front limiting rib
128 rear limiting rib
20 fixing assembly
210 hook
211 anchor portion
212 restoring element
213 pivot shaft
214 abutting portion
220 blocking rod
230 driving element
231 limiting element
240 restoring element
250 bracket
251 positioning hole
260 housing
261 opening
270 locking element
271 restoring element
280 telescopic adjusting element
281 wire
290 linkage rod
291 elastic element
30 indicating assembly
310 operating element
311 channel
3111 opening
312 guiding portion
320 first restoring element
330 linkage element
331 first connector
332 second connector
333 third connector
340 indicating element
341 first arm
342 second arm
343 pivot portion
344 first indicating portion
345 second indicating portion
346 driving portion
3461 through portion
350 second restoring element
360 fixing element
370 spacer
1S child safety seat
100S headrest portion
101S body
101aS upper edge
101bS lower edge
102S connecting plate
1021S first groove
103S extending portion
110S headrest covering cloth
111S first groove
120S operating element
130S driving element
131S abutting portion
132S accommodating space
140S restoring spring
50S locking element
160S sliding block
200S backrest portion
201aS upper edge
210S first turning portion
220S sliding groove
230S adjusting groove
240S backplane
241S second groove
300S seat portion
310S second turning portion
400S safety belt
1T child safety seat
100T headrest portion
110T buffer portion
120T board portion
130T first vent
140T first vent region
H1 vertical distance
D1 transverse distance
200T backrest portion
201T sliding groove
202T opening
203T engagement portion
210T front cover
1220T rear cover
230T side wing
240T second vent
250T second vent region
H2 vertical distance
D2 transverse distance
260T third vent
270T third vent region
270AT surrounding region
270BT middle region
H3 vertical distance
D3 transverse distance
280T fourth vent
90T fourth vent region
300T seat portion
301T locking groove
302T engagement groove
303T accommodating portion
400T buckle storage structure
410T first storage space
420T second storage space
430T adsorbing element
500T backrest locking structure
510T locking element
511T first end
512T second end
513T operating portion
520T restoring element
600T seat angle adjusting structure
610T supporting element
611T protruding surface
612T non-protruding surface
613T pivot end
614T adjusting portion
615T connecting portion
620T rotating shaft

### DETAILED DESCRIPTION

In order to explain the whole concept of the present disclosure more clearly, the following detailed description will be made by way of example with reference to the attached drawings of the specification.

It should be noted that in the following description, many specific details are set forth in order to fully understand the present disclosure. However, the present disclosure can be implemented in other ways different from those described here. Therefore, the protection scope of the present disclosure is not limited by the specific embodiments disclosed below.

In addition, in the description of the present disclosure, it should be understood that the terms “center”, “up”, “down”, “front”, “back”, “left”, “right”, “vertical”, “horizontal”, “top”, “bottom”, “inside”, “outside”, “axial”, “radial”, “circumferential”, etc. indicate the orientation or positional relationship based on the orientation or positional relationship shown in the drawings, which are only for the convenience of describing the present disclosure and simplifying the description, rather than indicating or implying that the indicated device or component must have a specific orientation, or must be constructed and operated in a specific orientation, and therefore should not be construed as a limitation on the present disclosure.

In the present disclosure, unless otherwise specified and limited, the terms “installed”, “connected”, “coupled” and “fixed” should be understood broadly, for example, may be fixed, detachable or integrated; or may be directly connected or indirectly connected through an intermediate medium, and may be in an internal communication of two components or an interaction between two components. However, direct connection means that two connected subjects do not build a connection relationship through excessive structure, but only form an integrated part through a connection structure. For those of ordinary skill in the art, the specific meanings of the above terms in the present disclosure can be understood according to specific situations.

In the present disclosure, unless otherwise specified and limited, a first feature “on” or “under” a second feature may be in direct contact between the first and second features, or in indirect contact between the first and second features through an intermediate medium. In the description of this specification, the description referring to the terms “an embodiment”, “some embodiments”, “example”, “specific example” or “some examples” means that the specific features, structures, materials or characteristics described in connection with the embodiment or example are included in at least one embodiment or example of the present disclosure. In this specification, the schematic expressions of the above terms do not necessarily refer to the same embodiment or example. Furthermore, the specific features, structures, materials or characteristics described may be combined in any one or more embodiments or examples in a suitable manner.

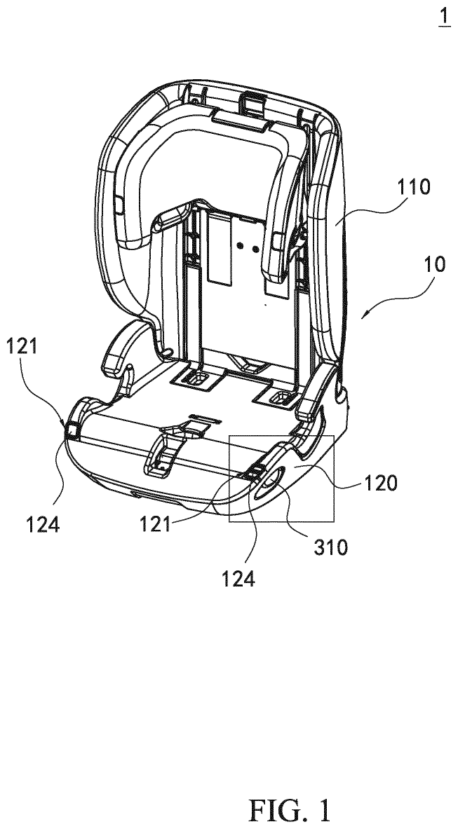

FIG. 1 is a perspective view of a child safety seat 1 of the present disclosure, in which an operating element 310 is not actuated.

Referring to FIG. 1, a child safety seat 1 may include a seat body 10. The seat body 10 is used to support a child (passenger) sitting on the child safety seat 1, and forms a main structure of the child safety seat 1. The seat body 10 may include a backrest 110 and a base 120. The backrest 110 may be used to support the head and the back of a passenger. The base 120 may be used to support the hip and the legs of the passenger.

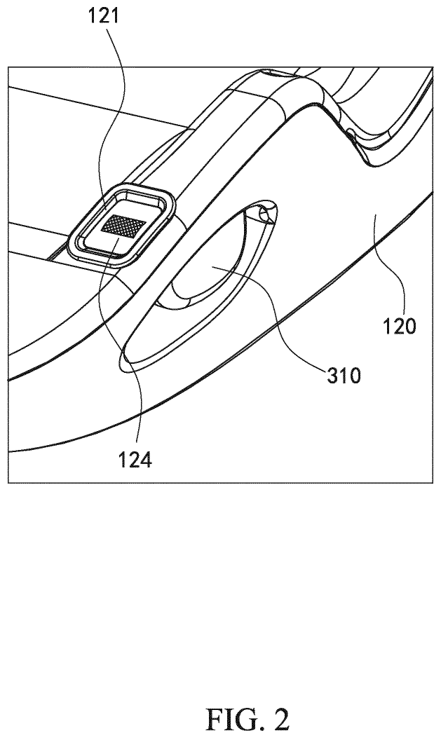

FIG. 2 is a partial enlarged view of FIG. 1.

Referring to FIGS. 1 and 2, both sides of the base 120 may protrude upward, thereby providing support for the hands of the passenger and preventing the passenger from transversely slipping out of the base 120. A front part (a part away from the backrest 110) of one side of the base 120 may be provided with an indicating window 121. For example, the indicating window 121 refers to a hollow part that may expose an interior of the child safety seat 1. The indicating window 121 may be formed in a rectangular shape, and the present disclosure is not limited thereto.

Optionally, the indicating window 121 is formed in a square shape, a circle shape, a triangle shape, or other shapes.

Although two indicating windows 121 are shown in FIG. 1, it can be understood that the present disclosure may only have at least one indicating window 121.

The indicating window 121 may generally face the above or front of the child safety seat 1. A setting position of the indicating window 121 is not limited by the embodiment of the present disclosure, and the indicating window 121 may be disposed at other positions on the seat body 10 which are convenient for users to observe.

In an embodiment, as shown in FIG. 1, the base 120 is provided with two indicating windows 121, and the two indicating windows 121 may be symmetrically located at front parts of both sides of the base 120 of the child safety seat 1.

The indicating window 121 may be covered by a transparent component 124. The transparent component 124 may enable the child safety seat 1 have a closed housing, and an interior of the child safety seat 1 may be observed at the indicating window 121. The transparent component 124 may be formed of glass, resin or other transparent materials.

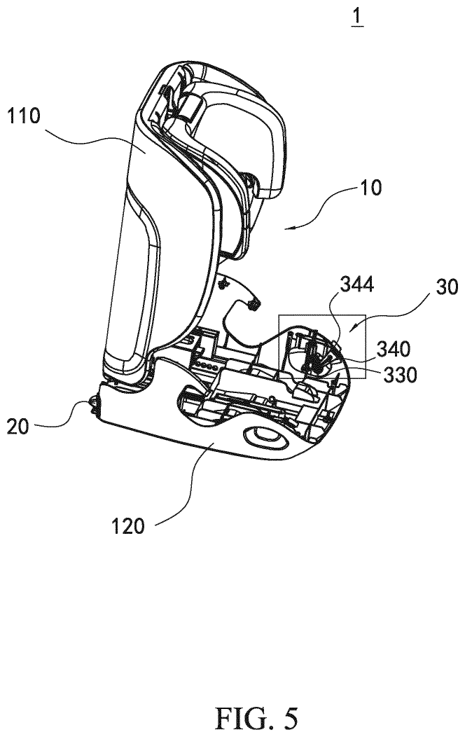

When the fixing assembly 20 (see FIG. 5, which will be described in detail below) is unlocked, the indicating window 121 may display one color (e.g., red), and when the fixing assembly 20 is locked, the indicating window 121 may display another color (e.g., green).

A side part of the child safety seat 1 may be formed with a through hole, and an operating element 310 (described in detail below) may be exposed from the through hole.

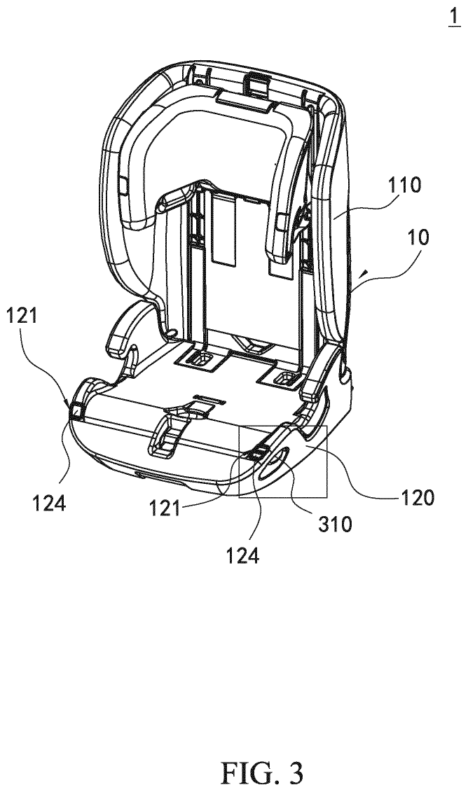

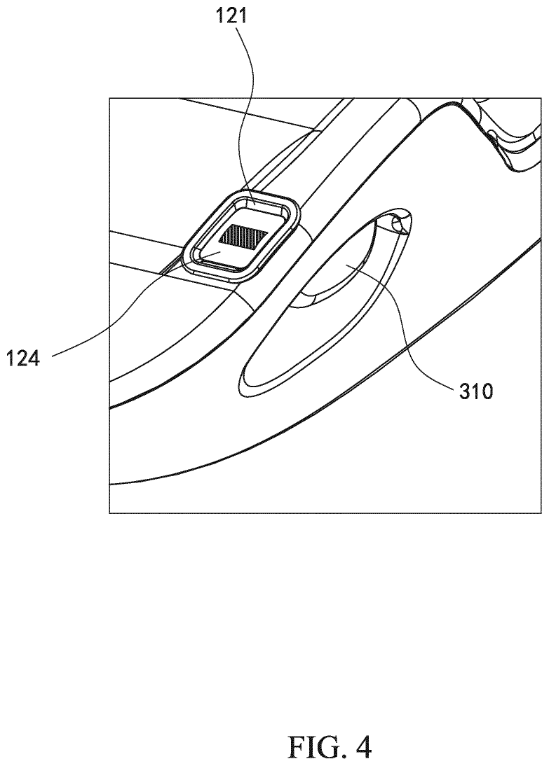

FIG. 3 is a perspective view of the child safety seat 1 of the present disclosure, in which the operating element 310 is actuated. FIG. 4 is a partial enlarged view of FIG. 3.

The operating element 310 may be actuated (for example, pushed by an operator's finger) to be linked with the fixing assembly 20 (this process will be described in detail below).

The operating element 310 may be actuated in at least one of an upward direction, a downward direction, a forward direction, and a backward direction with respect to the child safety seat 1, and the present disclosure is not limited thereto.

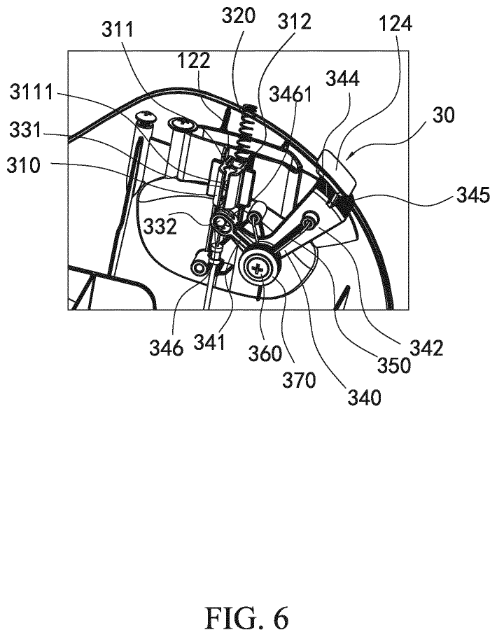

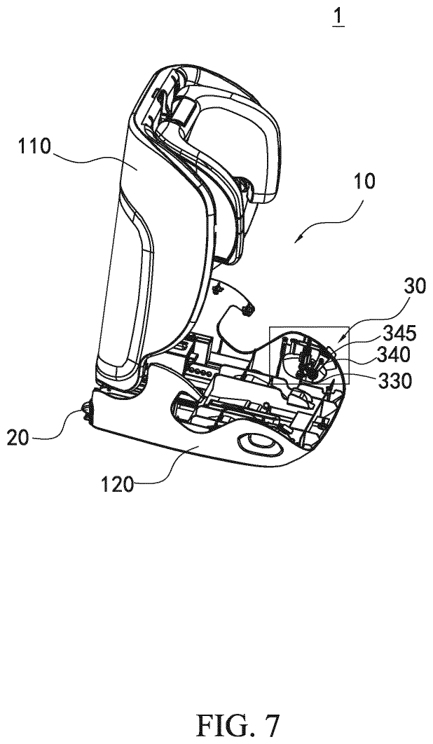

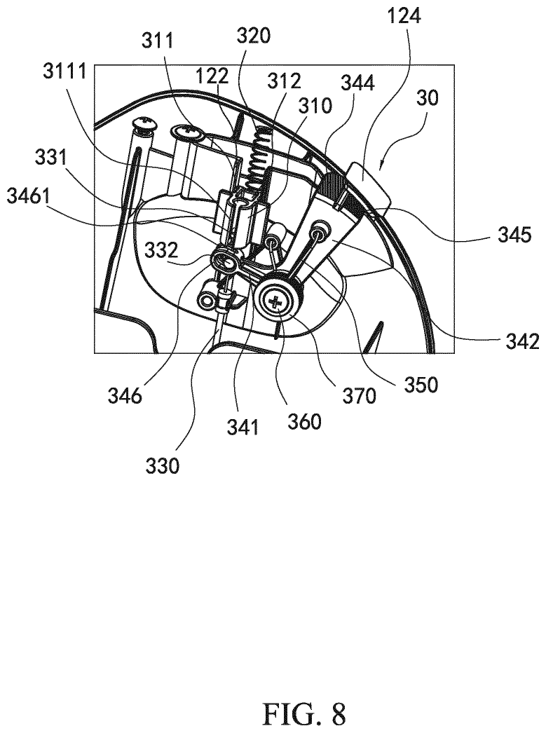

FIG. 5 is a perspective view of the child safety seat 1 of the present disclosure, in which a part of the child safety seat 1 is removed to show an internal structure, and the indicating element 340 is at a position where the first indicating portion 344 is exposed from the indicating window 121 (see FIG. 4). FIG. 6 is a partial enlarged view of FIG. 5. FIG. 7 is a perspective view of the child safety seat 1 of the present disclosure, in which a part of the child safety seat 1 is removed to show the internal structure, and the indicating element 340 is at a position where the second indicating portion 345 exposes the indicating window 121 (see FIG. 4). FIG. 8 is a partial enlarged view of FIG. 7. The indicating element 340 may be located at a front end of the seat body 10, and the fixing assembly 20 may be located at a rear end of the seat body 10, and the fixing assembly 20 is configured to be operable to slide relative to the rear end of the seat body 10.

Referring to FIG. 5, the child safety seat 1 may further include a fixing assembly 20 and an indicating assembly 30. The fixing assembly 20 may fix the child safety seat 1 to a seat of the vehicle. The indicating assembly 30 may indicate a state of the fixing assembly 20. Specifically, the indicating assembly 30 may indicate whether the fixing assembly 20 is in a locked state that the fixing assembly 20 is fixed to the seat of the vehicle or an unlocked state that the fixing assembly 20 is separable from the seat of the vehicle. The indicating assembly 30 may be disposed on an inner side wall of the base 120 of the child safety seat 1, and the present disclosure is not limited thereto. The position and number of the indicating assembly 30 may correspond to the position and number of the indicating windows 121. That is, when the child safety seat 1 has two indicating windows 121, the child safety seat 1 correspondingly has two indicating assemblies 30.

The indicating assembly 30 may include an operating element 310 and a linkage element 330. The linkage element 330 may connect other parts of the indicating assembly 30 to the fixing assembly 20. The linkage element 330 may be a steel wire or a flexible wire made of other materials. A first end of the linkage element 330 may be connected to the operating element 310, and a second end of the linkage element 330 may be connected to the fixing assembly 20, so that the linkage element 330 can be actuated to drive the fixing assembly 20 to be unlocked. The indicating element 340 is connected to the fixing assembly 20 through the linkage element 330, and a distance between the indicating element 340 and the first end is smaller than a distance between the indicating element 340 and the second end.

The child safety seat 1 includes a left operating element, a left indicating element, a left fixing assembly and a left linkage element, which are located on a left side of the seat body 10, and a right operating element, a right indicating element, a right fixing assembly and a right linkage element, which are located on a right side of the seat body 10, wherein the left operating element, the left indicating element and the left fixing assembly are respectively connected to the left linkage element, and the right operating element, the right indicating element and the right fixing assembly are respectively connected to the right linkage element.

Referring to FIGS. 6 and 8, the indicating assembly 30 may include an operating element 310. The operating element 310 is slidably disposed inside a base 120 of the child safety seat 1. For example, the operating element 310 may be disposed on an inner side wall of the base 120, and the operating element 310 may slide substantially in an up-and-down direction. The operating element 310 may include a guiding portion 312. The guiding portion 312 may be used to guide the sliding of the operating element 310. The sliding of the operating element 310 may be realized by restraining the guiding portion 312 of the operating element 310 in a sliding groove 122 extending in the up-and-down direction, and the present disclosure is not limited thereto. The sliding groove 122 may be formed in an inner side of the base 120. A part of the operating element 310 may protrude to an external of the child safety seat 1.

The operating element 310 may include a channel 311. The channel 311 may be formed in a cylindrical shape. The channel 311 may extend along a moving direction of the operating element 310. For example, in the case where the operating element 310 moves in the up-and-down direction of the child safety seat 1, the channel 311 may extend in the up-and-down direction. An opening 3111 may be formed in the channel 311. The opening 3111 may be a slit extending along a length direction of the channel 311 (i.e., along an axial direction of the cylindrical shape).

The linkage element 330 may have a first connector 331, which may be located at an end of the linkage element 330. Specifically, the first connector 331 is located inside the channel 311 and can slide in the channel 311. The above-mentioned slit may facilitate a traction rope (such as the above-mentioned steel wire or flexible wire made of other materials) of the linkage element 330 to pass through to install the first connector 331. When the fixing assembly 20 is in an unlocked state, the first connector 331 may be located at an upper middle position of the channel 311. When the fixing assembly 20 is in a locked state, the first connector 331 may be located at a lower position of the channel 311. That is, when the operating element 310 is operated (actuated upward), the first connector 331 is driven by the operating element 310, thereby causing the fixing assembly 20 to be unlocked.

The indicating assembly 30 may include a first restoring element 320. The first restoring element 320 may be a coil spring, and the present disclosure is not limited thereto. The first restoring element 320 may be disposed between the operating element 310 and a housing of the base 120 to provide a restoring force toward an initial position to the operating element 310. The initial position may be a position corresponding to the locked state of the fixing assembly 20.

Referring to FIG. 1 and FIG. 5, a left side and a right side of the child safety seat 1 may be respectively provided with one operating element 310, and the present disclosure is not limited thereto.

In one embodiment, the operating element 310 on one side of the child safety seat 1 may be actuated to control the unlocking of the fixing assembly 20 on that side, and the operating element 310 on the other side of the child safety seat 1 may be actuated to control the unlocking of the fixing assembly 20 on that other side.

In another embodiment, the fixing assemblies 20 on both sides of the child safety seat 1 may be linked with each other via an appropriate mechanism, so that the operating element 310 on either side of the child safety seat 1 may be actuated to simultaneously control the simultaneous unlocking of the fixing assemblies 20 on both sides of the child safety seat 1.

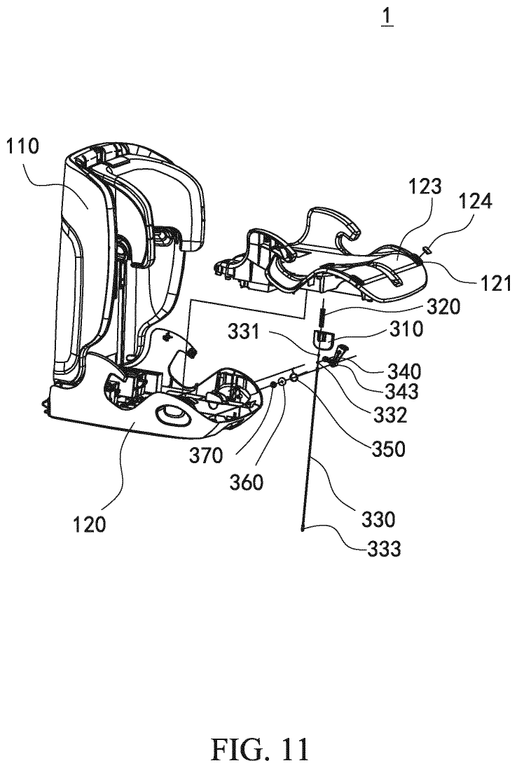

The indicating assembly 30 may include an indicating element 340. The indicating element 340 can be pivotally fixed to the base 120 by means of a fixing element 360. The fixing element 360 may pass through a pivot portion 343 of the indicating element 340 (see FIG. 11). A spacer 370 may be provided between the pivot portion 343 and the fixing element 360. The pivot portion 343 may correspond to a pivot shaft of the indicating element 340.

The indicating element 340 may have a first arm 341 and a second arm 342. The first arm 341 and the second arm 342 extend outward from the pivot shaft of the indicating element 340, respectively. The first arm 341 and the second arm 342 may have an angle therebetween. A driving portion 346 may be formed at an end of the first arm 341. The driving portion 346 may be formed as an elongate through hole. A length direction of the driving portion 346 may direct to the pivot shaft of the indicating element 340.

The linkage element 330 may have a second connector 332. The second connector 332 may be located inside the driving portion 346. The second connector 332 may be below the first connector 331 and at a certain distance from the first connector 331. The second connector 332 may move freely in the driving portion 346 along the length direction of the driving portion 346, so that a linear movement of the second connector 332 causes a pivoting movement of the indicating element 340, and vice versa. Specifically, a through portion 3461 may be disposed on the driving portion 346. The linkage element 330 may pass through the driving portion 346 via the through portion 3461.

The second arm 342 may be formed as a substantially fan-shaped sheet. An end of the second arm 342 may be bent to form a first indicating portion 344 and a second indicating portion 345. The first indicating portion 344 and the second indicating portion 345 may be disposed adjacent to each other. The first indicating portion 344 and the second indicating portion 345 may be perpendicular to the second arm 342, and the present disclosure is not limited thereto. The first indicating portion 344 and the second indicating portion 345 may have a same dimension. A dimension of the indicating window 121 (see FIG. 1) is smaller than or equal to a dimension of each of the first indicating portion 344 and the second indicating portion 345, so that the first indicating portion 344 and the second indicating portion 345 are not exposed through the indicating window 121 at the same time. Since the linear movement of the second connector 332 causes the indicating element 340 to pivot, the first indicating portion 344 may indicate the unlocked state of the fixing assembly 20, and the second indicating portion 345 may indicate the locked state of the fixing assembly 20 (which will be described in more detail below).

The first indicating portion 344 and the second indicating portion 345 may have different colors. For example, a surface of the first indicating portion 344 facing the indicating window 121 may be red, and a surface of the second indicating portion 345 facing the indicating window 121 may be green, and the present disclosure is not limited thereto.

The indicating assembly 30 may include a second restoring element 350. The second restoring element 350 may be a torsion spring, and the present disclosure is not limited thereto. The second reduction member 350 may be located by the spacer 370, and the spacer 370 may be located by the fixing element 360. The second restoring element 350 may be disposed between the pivot portion 343 of the indicating element 340 and the housing of the base 120 to apply a restoring force to the indicating element 340. The restoring force may constantly bias the indicating element 340 to a position where the first indicating portion 344 corresponds to the indicating window 121.

In one embodiment, the child safety seat 1 may have both the first restoring element 320 and the second restoring element 350.

In one embodiment, the child safety seat 1 may have one of the first restoring element 320 and the second restoring element 350.

In one embodiment, the child safety seat 1 may not have the first restoring element 320 and the second restoring element 350.

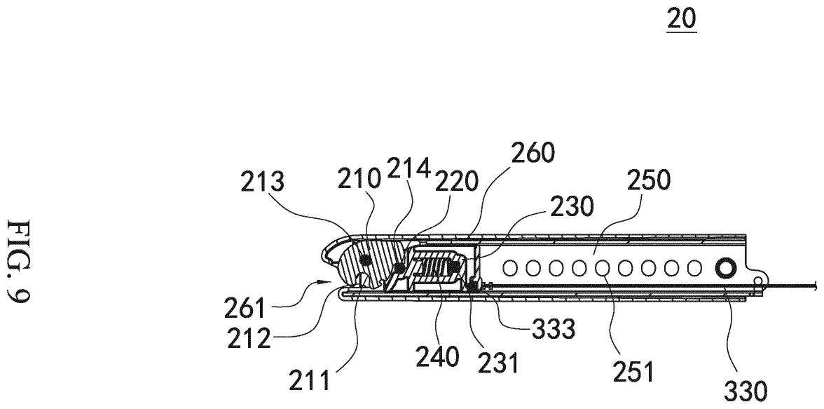

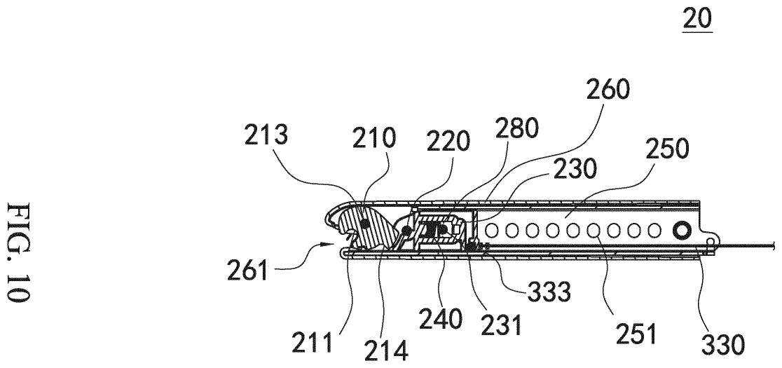

FIG. 9 is a cross-sectional view of the fixing assembly 20 of the child safety seat 1 of the present disclosure, in which the fixing assembly 20 is in a locking position. FIG. 10 is a cross-sectional view of the fixing assembly 20 of the child safety seat 1 of the present disclosure, in which the fixing assembly 20 is in an unlocking position.

Referring to FIGS. 9 and 10, the fixing assembly 20 may fix the child safety seat 1 to a corresponding interface on the seat of the vehicle. The fixing assembly 20 may be an ISOFIX, and the present disclosure is not limited thereto. The child safety seat 1 may include two fixing assemblies 20 symmetrically arranged at both sides of the child safety seat 1. The fixing assembly 20 may extend backward from a rear part of the child safety seat 1 (as shown in FIGS. 5 and 7).

Referring to FIGS. 9 and 10, the fixing assembly 20 may include a housing 260 to form an appearance of the fixing assembly 20. A left end of the housing 260 (an end of the fixing assembly 20 away from the seat body 10) may form an opening 261.

The fixing assembly 20 may include a hook 210. The hook 210 may be pivotally connected to a position near the opening 261 of the housing 260 by means of a pivot shaft 213. An anchor portion 211 may be formed on the hook 210. When the fixing assembly 20 is in the unlocking position (as shown in FIG. 10), the anchor portion 211 may face the opening 261 of the housing 260. When the fixing assembly 20 is in the locking position (as shown in FIG. 9), the hook 210 may be pivoted counterclockwise so that the anchor portion 211 faces downward. In this way, the anchor portion 211 may receive and lock a corresponding component (for example, a fixing rod) on the seat of the vehicle.

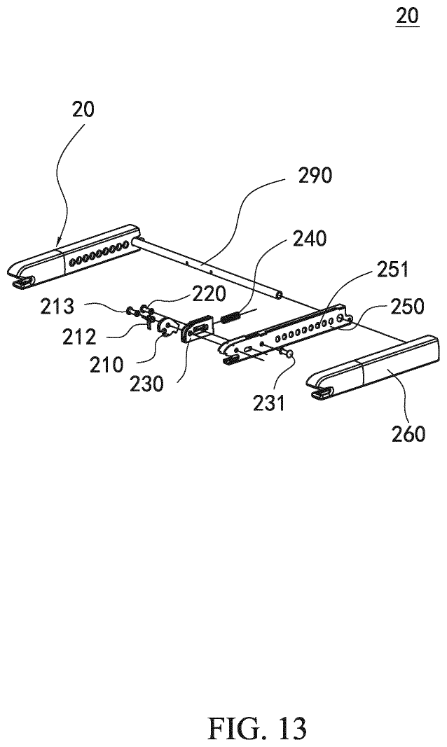

The hook 210 may be biased by a restoring element 212 (see FIGS. 9 and 13) to tend to pivot from the locking position to the unlocking position. The restoring element 212 may be a torsion spring.

The fixing assembly 20 may include a driving element 230. The driving element 230 may be located at a right side of the hook 210 (farther away from the opening 261 of the housing 260 than the hook 210). The driving element 230 is slidably disposed in the housing 260 of the fixing assembly 20. An end of the linkage element 330 opposite to the first connector 331 is formed as a third connector 333. The third connector 333 is connected to the driving element 230. A blocking rod 220 is connected to a left side of the driving element 230. A cavity may be formed in the driving element 230. The restoring element 240 may be located in the cavity. The restoring element 240 may be a coil spring, and the present disclosure is not limited thereto. The restoring element 240 may be disposed between the driving element 230 and the limiting element 231, so as to apply a thrust force toward the hook 210 to the driving element 230. The limiting element 231 may be fixedly disposed in the fixing assembly 20.

As shown in FIGS. 9 and 10, an abutting portion 214 is formed on the right side of the hook 210. When the fixing assembly 20 is in the locking position, the blocking rod 220 may abut against the abutting portion 214 of the hook 210 from below, thereby preventing the hook 210 from pivoting. Please refer to FIG. 8, the driving element 230 is located near the hook 210, and the linkage element 330 is tightened. A second connector 332 of the linkage element 330 pulls the indicating element 340 to pivot against a force of the second restoring element 350, so that the second indicating portion 345 faces the indicating window 121 to remind the user that the fixing assembly 20 is in the locking position.

When the operating element 310 is actuated, the first connector 331 and the second connector 332 move upward together with the operating element 310 (from a position shown in FIG. 8 to a position shown in FIG. 6). It should be understood that the “upward movement” described herein is only an example, and a moving direction of the operating element 310 may be other directions. The upward movement of the first connector 331 may be transmitted to the other end of the linkage element 330, thereby the driving element 230 is pulled from a state shown in FIG. 9 to a state shown in FIG. 10. When the driving element 230 is pulled by the linkage element 330, the blocking rod 220 no longer abuts against the hook 210, so that the hook 210 may pivot to the unlocking position under an action of the restoring element 212. Please refer to FIG. 6, after the hook 210 pivots to the unlocking position, the hook 210 abuts against the driving element 230, and the driving element 230 is located at a position away from the hook 210. At this time, the linkage element 330 is released, and the indicating window 121 is changed by the indicating element 340 from displaying the second indicating portion 345 to displaying the first indicating portion 344 under a restoring force of the second restoring element 350, so as to remind the user that the fixing assembly 20 is in the unlocking position.

As shown in FIGS. 9 and 10, the fixing assembly 20 may include a bracket 250. The bracket 250 may be formed of metal (e.g., steel), and the present disclosure is not limited thereto. The bracket 250 may have a good strength enough to withstand an impact force applied to the child safety seat 1 when the vehicle is hit. The pivot shaft 213 may be fixed to the bracket 250. That is, the hook 210 may be pivotally connected to the bracket 250 by means of the pivot shaft 213. The limiting element 231 may be connected and fixed to the bracket 250. A plurality of positioning holes 251 may be formed in the bracket 250. The fixing assembly 20 may extend and retract relative to the seat body 10. The plurality of positioning holes 251 may extend along a length direction of the fixing assembly 20. The length direction may be the extending or retracting direction of the fixing assembly 20. The plurality of positioning holes 251 may be formed in a circular shape, an oval shape or an oblong shape, and the present disclosure is not limited thereto. The blocking rod 220 is slidably connected to the bracket 250 and fixed to the driving element 230.

FIG. 11 is an exploded perspective view of the child safety seat 1 of the present disclosure.

Referring to FIG. 11, the base 120 may include a base upper cover 123. The base upper cover 123 may be detached from the base 120, thus facilitating the installation of a component inside the base 120.

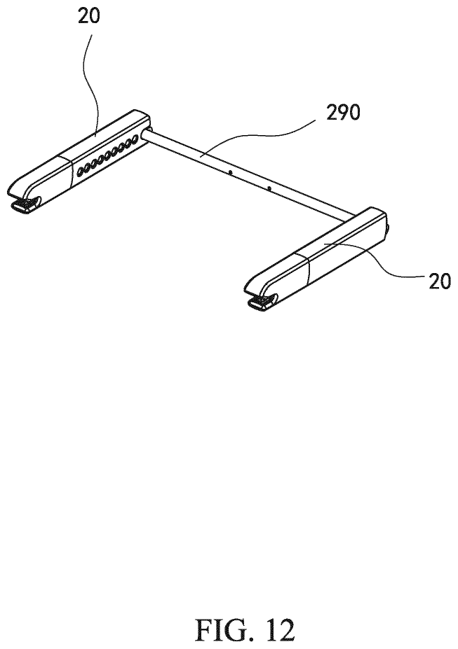

FIG. 12 is a perspective view of a part of components of the child safety seat of the present disclosure, in which two fixing assemblies are fixed together by a linkage rod. FIG. 13 is an exploded perspective view of a part of components of the child safety seat of the present disclosure.

The child safety seat 1 may include two fixing assemblies 20. The two fixing assemblies 20 may be connected via the linkage rod 290, so that the two fixing assemblies 20 are synchronised for movement. The linkage rod 290 may be located inside the base 120. The linkage rod 290 may be fixed to the brackets 250 of the two fixing assemblies 20 (see FIGS. 9 and 10), respectively. Specifically, the linkage rod 290 may be fixed to a rear end (right end as shown in FIG. 9) of the bracket 250. Inner sides (sides facing each other) of the housings 260 of the two fixing assemblies 20 may be formed with holes corresponding to the positioning holes 251. The bracket 250 may be formed as a bent sheet.

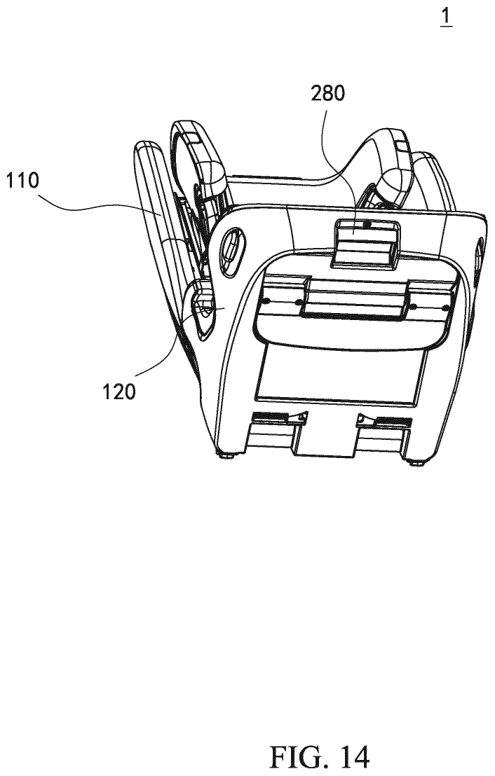

FIG. 14 is a bottom perspective view of the child safety seat 1 of the present disclosure.

A telescopic adjusting element 280 may be disposed at the bottom of the base 120. The telescopic adjusting element 280 is slidably connected to the base 120 for unlocking the sliding of the locking fixing assembly 20. The telescopic adjusting element 280 may be actuated to release the fixing of the fixing assembly 20 to the seat body 10. That is, when the telescopic adjusting element 280 is actuated, the fixing assembly 20 may slide to extend out or retract into the base 120. This will be described in more detail below.

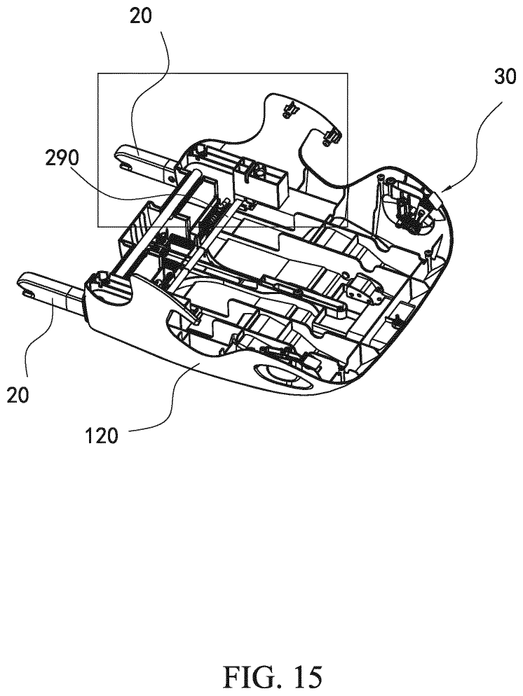

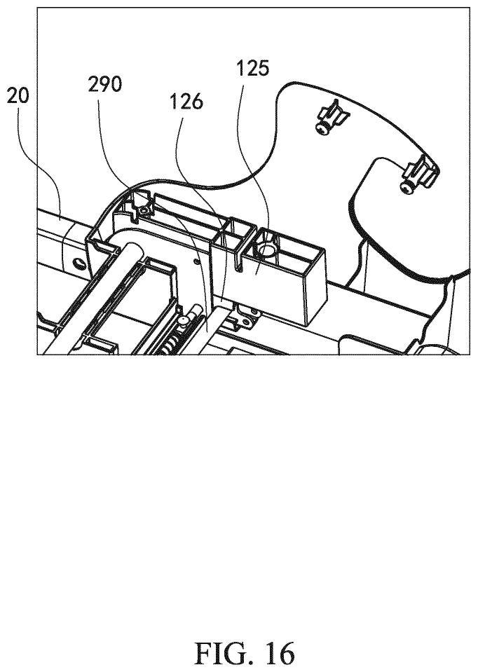

FIG. 15 is a perspective view of the base 120 of the child safety seat 1 of the present disclosure, in which a part of the base 120 is removed to show an internal structure. FIG. 16 is a partial enlarged view of FIG. 15.

The linkage rod 290 may pass through a part of the base 120. The base 120 may include a fixing block 125 and a U-shaped element 126. A channel may be formed between the bottom of the fixing block 125 and the U-shaped element 126 for the fixing assembly 20 to slide therein relative to the base 120. When the fixing assembly 20 extends to a maximum length relative to the seat body 10, the linkage rod 290 may abut against the U-shaped element 126 in the base 120, thus defining a maximum length that the fixing assembly 20 can extend. The U-shaped element 126 may be a U-shaped iron sheet, and the present disclosure is not limited thereto.

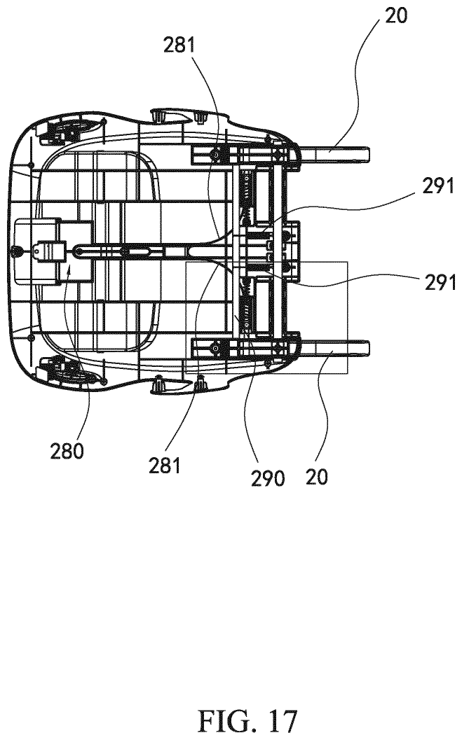

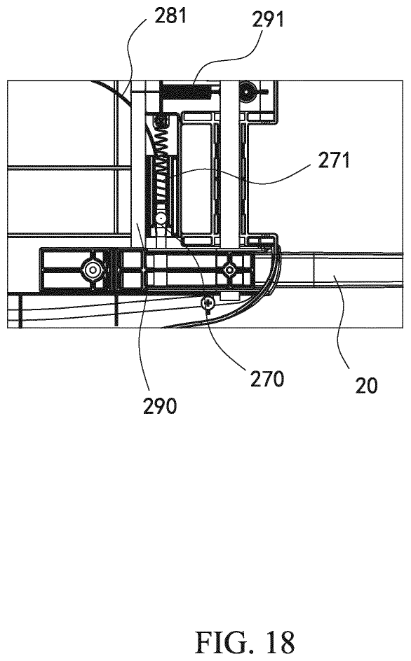

FIG. 17 is a top view of the base 120 of the child safety seat 1 of the present disclosure, in which a part of the base 120 is removed to show the internal structure. FIG. 18 is a partial enlarged view of FIG. 17.

The locking element 270 is slidably disposed in the base 120. When the fixing assembly 20 telescopically slides, the locking element 270 may pass through one of the positioning holes 251, thereby locking the fixing assembly 20 with the seat body 10. The telescopic adjusting element 280 may be linked with the locking element 270 (for example, by means of a flexible wire 281). The wire 281 may be a steel wire, and the present disclosure is not limited thereto. When the telescopic adjusting element 280 is actuated, the locking element 270 is driven by the telescopic adjusting element 280 to leave the positioning hole 251, thereby unlocking the fixing assembly 20 from the seat body 10. A restoring element 271 may be disposed between the base 120 and the locking element 270. The restoring element 271 may be a coil spring, and the present disclosure is not limited thereto. The restoring element 271 may provide a thrust force to the locking element 270 so that the locking element 270 tends to be inserted into the positioning hole 251. Thus, when the telescopic adjusting element 280 is not actuated, the fixing assembly 20 may freely slide for a certain distance until the locking element 270 is actuated and inserted into one of the positioning holes 251.

When the child safety seat 1 has two fixing assemblies 20, the number of the locking element 270, the restoring element 271 and the wire 281 may be correspondingly two. The telescopic adjusting element 280 may be linked with two locking elements 270 simultaneously by means of two wires 281.

The elastic element 291 may be disposed between the linkage rod 290 and the base 120, thereby exerting a pulling force on the linkage rod 290. The elastic element 291 tends to make the fixing assembly 20 extend out of the seat body 10. The restoring element 271 may be a coil spring, and the present disclosure is not limited thereto. The number of elastic element 291 may be one, two or other numbers.

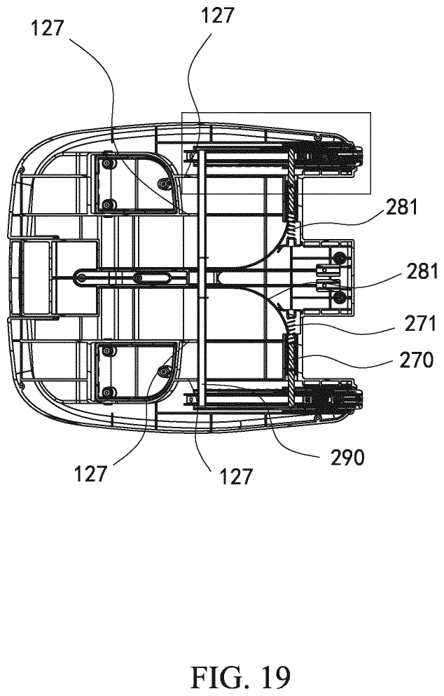

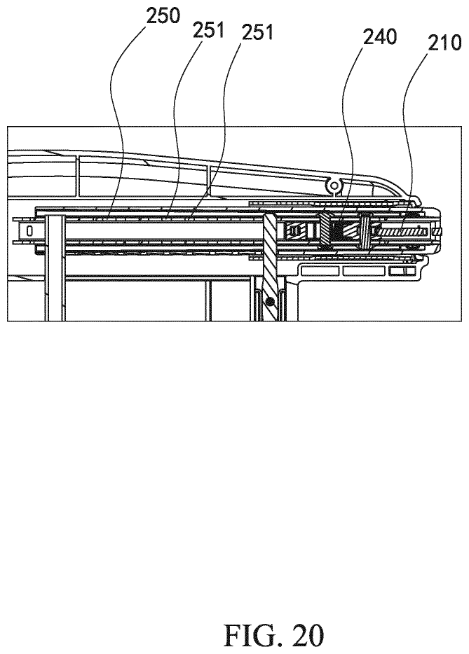

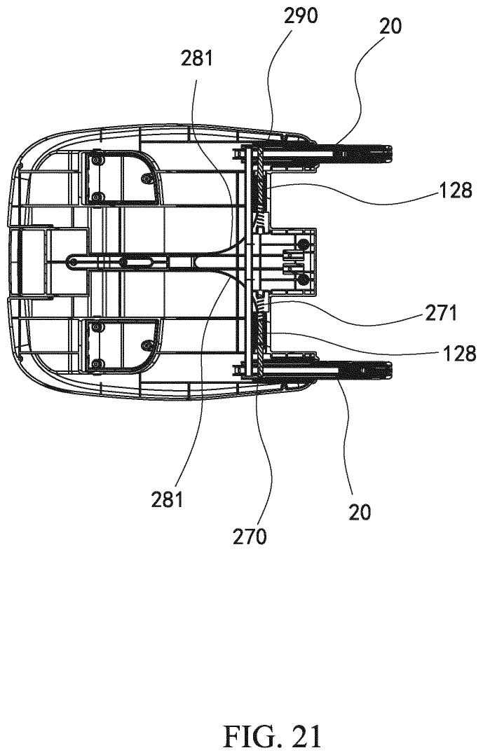

FIG. 19 is a cross-sectional view of the base 120 of the child safety seat 1 of the present disclosure, in which the fixing assembly 20 is in an extended position. FIG. 20 is a partial enlarged view of FIG. 19. FIG. 21 is a cross-sectional view of the base 120 of the child safety seat 1 of the present disclosure, in which the fixing assembly 20 is in a retracted position.

The two side walls of the bracket 250 may be respectively provided with the same number of positioning holes 251 with corresponding positions. The base 120 may include a front limiting rib 127 and a rear limiting rib 128. The front limiting rib 127 and the rear limiting rib 128 may jointly limit a moving distance of the linkage rod 290, and further limit a telescopic moving distance of the fixing assembly 20. The number of the front limiting rib 127 and the rear limiting rib 128 may be multiple, respectively.

The present disclosure may include the following technical solutions.

The present disclosure may provide a child safety seat including a seat body, a fixing assembly, and an indicating assembly. The indicating assembly is disposed on the seat body and includes an indicating element, and the indicating element is linked with the fixing assembly, so that when the fixing assembly is unlocked, the indicating element is held in a first position, and when the fixing assembly is locked, the indicating element is held in a second position.

Optionally, the indicating element is pivotally connected to the seat body.

Optionally, the child safety seat includes an operating element and a linkage element. The operating element is slidably disposed on the seat body and can be actuated to drive the fixing assembly to be unlocked through the linkage element.

Optionally, the operating element drives the indicating element to pivot through the linkage element.

Optionally, the operating element includes a guiding portion for guiding the operating element to slide on the base of the child safety seat.

Optionally, the operating element includes a channel, and the channel extends along a moving direction of the operating element.

Optionally, an opening is formed on the channel, and the opening is a slit extending along a length direction of the channel.

Optionally, the fixing assembly includes a hook having an unlocking position corresponding to the unlocking of the fixing assembly and a locking position corresponding to the locking of the fixing assembly, and the hook is set to tend to move from the locking position to the unlocking position.

Optionally, the fixing assembly includes a driving element. The driving element prevents the hook from moving to the unlocking position when the driving element is not actuated, and the driving element allows the hook to move to the unlocking position when the driving element is actuated.

Optionally, the operating element is disposed to actuate the driving element via the linkage element.

Optionally, the indicating element is pivotally connected to the seat body and includes a first arm and a second arm, and the first arm is linked with the driving element via the linkage element.

Optionally, a driving portion is formed at an end of the first arm, and the driving portion is formed as an elongate through hole. A length direction of the driving portion is directed to a pivot shaft of the indicating element.

Optionally, the seat body includes a backrest and a base, and an indicating window leading to an interior of the seat body is formed in a front part of the base.

Optionally, the indicating element includes a first indicating portion and a second indicating portion, which are located at an end of the second arm. When the indicating element is held in the first position, the first indicating portion can be observed from an external of the seat body, and when the indicating element is held in the second position, the second indicating portion can be observed from the external of the seat body.

Optionally, the indicating element includes the first indicating portion and the second indicating portion. The first indicating portion is exposed through the indicating window when the indicating element is held in the first position and the second indicating portion is exposed through the indicating window when the indicating element is held in the second position.

Optionally, the indicating window is formed as a through hole, and the indicating window is covered with a transparent component.

Optionally, the fixing assembly is an ISOFIX.

Optionally, the linkage element is a wire.

Optionally, the child safety seat includes a first restoring element that exerts a thrust force to the operating element to tend to drive the operating element to return to an unactuated position.

Optionally, the child safety seat includes a second restoring element that exerts a torsional force to the indicating element to tend to drive the indicating element to move to a position where the first indicating portion can be observed from the external of the seat body.

Optionally, the child safety seat includes two fixing assemblies, and the two fixing assemblies are connected to each other via a linkage rod, so that the two fixing assemblies are synchronised for movement.

Optionally, the fixing assembly includes a bracket, and the hook is pivotally connected to the bracket.

Optionally, the fixing assembly can be telescopically disposed on the seat body, a plurality of positioning holes are formed on the bracket, and a limiting element selectively passes through one of the positioning holes, so that the fixing assembly is fixed to the seat body.

Optionally, the fixing assembly is disposed to tend to extend out of the seat body.

Optionally, the child safety seat includes a telescopic adjusting element which can be actuated to drive the limiting element to disengage from the plurality of positioning holes.

The present disclosure may further provide a child safety seat including a seat body and an ISOFIX. An indicating assembly is disposed on the seat body, and the indicating assembly includes an indicating element. The indicating element is linked with the ISOFIX, so as to indicate the locking and unlocking of the ISOFIX.

Optionally, the indicating element and the ISOFIX are connected to each other through a linkage element.

Optionally, when the ISOFIX is unlocked, the indicating element is held in a first position by a restoring element, and when the ISOFIX is locked, the ISOFIX drives the indicating element through the linkage, so that the indicating element is held in a second position.

Optionally, the seat body includes a backrest and a base, and an indicating window is formed on an upper surface of the base. The indicating window is located at an end of a side edge of the base away from the backrest.

Optionally, the indicating element includes a first indicating portion and a second indicating portion adjacent to each other, and the indicating element can be actuated to expose one of the first indicating portion and the second indicating portion via the indicating window.

Optionally, the seat body is provided with two indicating assemblies, and the two indicating assemblies indicate the locking and unlocking of the ISOFIX at different positions.

Optionally, the indicating element is pivotally connected inside the seat body.

Optionally, the child safety seat includes an operating element which is disposed on the seat body and drives the ISOFIX to be unlocked through the linkage element.

Optionally, the ISOFIX includes a driving element and a hook, and the operating element is linked with the driving element via the linkage element to drive the driving element to move from a position where the driving element blocks the hook to a position where the driving element separates from the hook.

Optionally, the child safety seat includes a bracket and a limiting element. A plurality of positioning holes are formed on the bracket, and the limiting element selectively passes through one of the positioning holes to fix the ISOFIX to the seat body.

Optionally, the ISOFIX can be telescopically disposed on the seat body and is forced to tend to extend out of the seat body.

The present disclosure may further provide an indicating assembly including an operating element, a linkage element and an indicating element. The operating element can be actuated to move the indicating element from one of a first position and a second position to the other of the first position and the second position, and the operating element is linked with a fixing assembly via the linkage element so that the operating element can be actuated to lock or unlock the fixing assembly.

Optionally, the indicating assembly is applied to the child safety seat described above.

The child safety seat 1 of the present disclosure can solve the technical problem that: the position of the indicating structure of the fixing assembly of the child safety seat in the prior art is close to a riding surface of the seat of the vehicle, so that the indicating structure is easily shielded and cannot play the function of reminding the user.

The indicating element 340 of the child safety seat 1 of the present disclosure can be arranged on the left side and/or the right side of the front end of the seat, so that the setting position of the indicating structure of the child safety seat 1 is observable, easy to be identified, and not easy to be shielded.

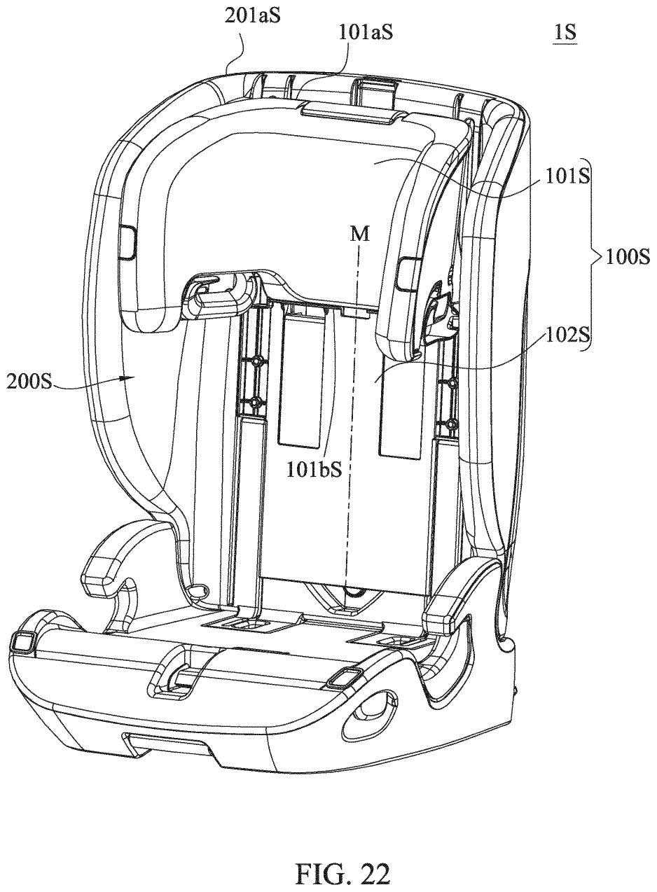

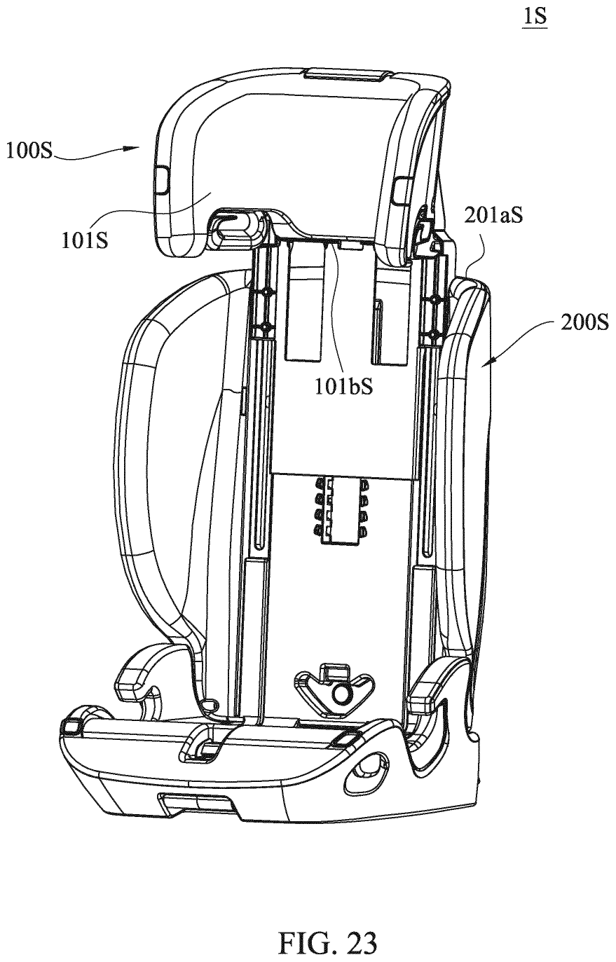

The present disclosure provides a child safety seat 1S with adjustable headrest height. Referring to FIGS. 22 and 23, FIGS. 22 and 23 respectively show a front perspective view of the child safety seat IS according to the present disclosure, in which the headrest portion 100S is in different positions.

As shown in FIG. 22, the child safety seat 1S includes a headrest portion 100S and a backrest portion 200S. Specifically, the headrest portion 100S includes a body 101S and a connecting plate 102S. The body 101S has an upper edge 101aS and a lower edge 101bS, and the connecting plate 102S may be connected to the lower edge 101bS of the body 101S to make the headrest portion 100S more stably connected to the backrest portion 200S. In an example, the connecting plate 102S may be disposed at a middle part of the lower edge 101bS of the body 101S, and more preferably, a center line M of the connecting plate 102S coincides with a midpoint of the lower edge 101bS of the body 101S.

As can be seen from FIG. 22 and FIG. 23, the headrest portion 100S can be adjusted to different heights relative to the backrest portion 200S, so as to be suitable for children with different sizes or heights. When the headrest portion 100S is in a relatively low position, it may be used by a child with a relatively small size or height (e.g., a child under three years old). At this time, a child sitting in the child safety seat 1S may be fixed by a five-point safety belt, and then the child safety seat is fixed to the vehicle by an ISOFIX and/or a Top Tether. For example, an example of “relatively low position” is shown in FIG. 22, and it should be understood that “relatively low position” is not limited to this position, but may also be other positions where the child is suitable to be fixed by the five-point safety belt. When the headrest portion 100S is adjusted to a relatively high position, it may be used by a child with a relatively large size or height (e.g., a child over three years old). In this case, the child safety seat and the child sitting on it may be fixed by the vehicle safety belt. For example, an example of “relatively high position” is shown in FIG. 23, and it should be understood that “relatively high position” is not limited to this position, but may also be other positions where the child safety seat and the child is suitable to be fixed by the vehicle safety belt instead of the five-point safety belt.

Further, the headrest portion 100S can move between the first position and the second position relative to the backrest portion 200S. For example, FIGS. 22 and 23 show one embodiment of a moving range of the headrest portion 100S relative to the backrest portion 200S. FIG. 22 shows the lowest position (i.e., the first position) of the headrest portion 100S relative to the backrest portion 200S, and when the headrest portion 100S is located at the lowest position, the upper edge 101aS of the body 101S of the headrest portion 100S does not exceed (i.e., is lower than or flush with) an upper edge 201aS of the backrest portion 200S. FIG. 23 shows the highest position (i.e., the second position) of the headrest portion 100S relative to the backrest portion 200S, and when the headrest portion 100S is located at the highest position, the lower edge 101bS of the body 101S of the headrest portion 100S is higher than the upper edge 201aS of the backrest portion 200S.

Here, for convenience of explanation, the moving range of the lower edge 101bS of the body 101S when the headrest portion 100S moves from the first position to the second position is defined as a “height adjustment stroke” of the headrest portion 100S relative to the backrest portion 200S.

It should be understood that the aforementioned “first position” and “lowest position” are not limited to the position shown in FIG. 22, and may also be located at other positions according to the need of the user. Similarly, the aforementioned “second position” and “highest position” are not limited to the position shown in FIG. 23, and may also be located at other positions according to the need of the user.

In addition, the “relatively low position” suitable for being fixed by the five-point safety belt and the “relatively high position” suitable for being fixed by the vehicle safety belt mentioned above and a critical position between them will be explained in detail later.

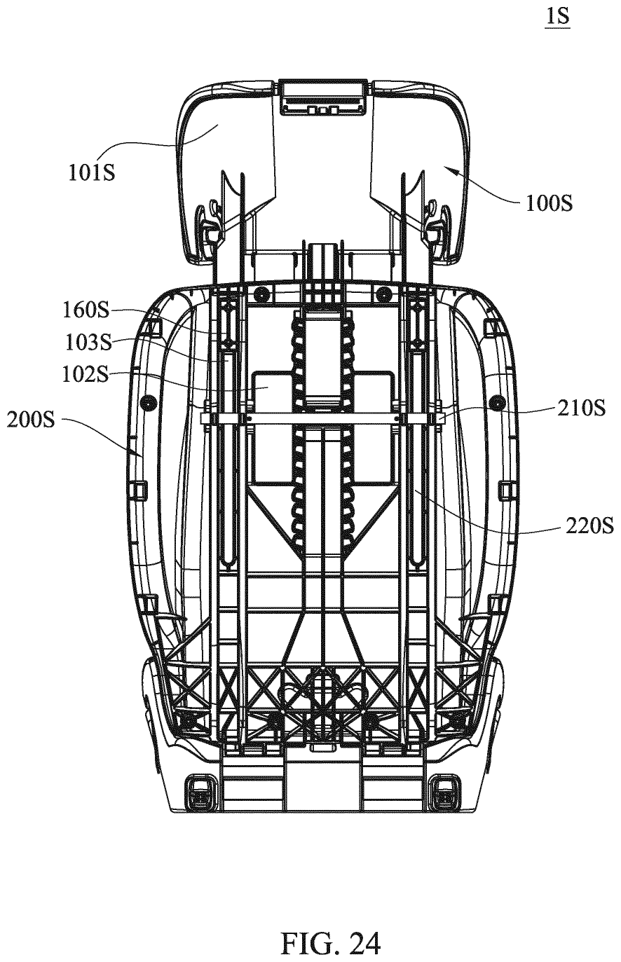

Referring to FIG. 24, a rear view of the child safety seat IS shown in FIG. 23 is shown.

In one embodiment, the headrest portion 100S may be slidably connected to the backrest portion 200S to be adjusted to different positions relative to the backrest portion 200S. As shown in FIG. 24, the headrest portion 100S may be provided with a sliding block 160S, and the backrest portion 200S may be correspondingly provided with a sliding groove 220S. The sliding block 160S may be coupled with and move along the sliding groove 220S, so that the headrest portion 100S may slide relative to the backrest portion 200S.

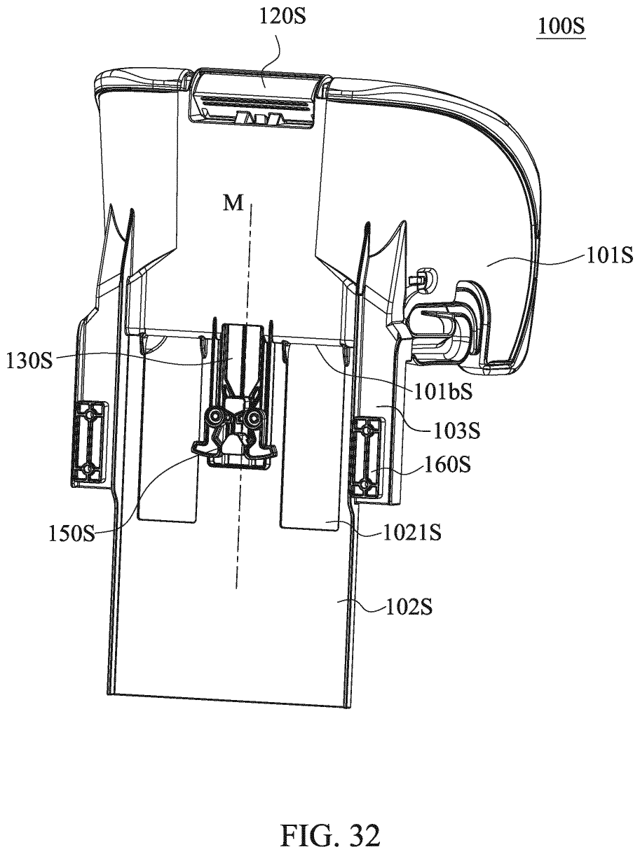

For example, the sliding block 160S may be disposed below the body 101S of the headrest portion 100S. Specifically, the number of the sliding block 160S may be set to two, and two sliding blocks 160S are disposed on two sides of the connecting plate 102S of the headrest portion 100S. For example, in order to better illustrate a structure of the sliding block 160S, reference may be made to FIG. 32 (FIG. 32 shows a perspective view of the headrest portion 100S, and other structures in FIG. 32 will be described in detail below). The headrest portion 100S may be provided with extending portions 103S extending from the lower edge 101bS of the body 101S and located at both sides of the connecting plate 102S, and sliding blocks 160S may be disposed on the extending portions 103S. The sliding blocks 160S may be fixedly connected to the extending portions 103S, or may be integrally formed with the extending portions 103S. In a preferred embodiment, the extending portions 103S located at both sides of the connecting plate 102S are symmetrically disposed with respect to the center line M of the connecting plate 102S.

Correspondingly, the number of the sliding groove 220S may also be set to two, and two sliding grooves 220S are respectively coupled to one of the sliding blocks 160S. In an embodiment, two sliding grooves 220S are symmetrically disposed on the backrest portion 200S and extend in a vertical direction respectively. A length of the sliding groove 220S (i.e. a length extending in the vertical direction on the backrest portion 200S) defines a slidable range of the sliding block 160S in the sliding groove 220S, that is, a height adjustment stroke of the headrest portion 100S relative to the backrest portion 200S. In one embodiment, the length of the sliding groove 220S may be substantially equal to a distance that the headrest portion 100S moves from the first position to the second position.

It should be understood that the present disclosure is not limited to the above arrangement, for example, a position of the sliding block 160S and a position of the sliding groove 220S may be interchanged, that is, the sliding groove 220S is disposed on the headrest portion 100S, and the sliding block 160S is disposed on the backrest portion 200S. The present disclosure is not limited to the above number, for example, one or more than two sliding blocks 160S and one or more than two sliding grooves 220S may be disposed. In addition, other sliding fit modes may be adopted as the sliding fit mode between the headrest portion 100S and the backrest portion 200S, such as a pin and a groove, or a slide bar and a slideway, and even other modes that can adjust the headrest portion 100S and the backrest portion 200S relatively other than the sliding fit may be adopted.

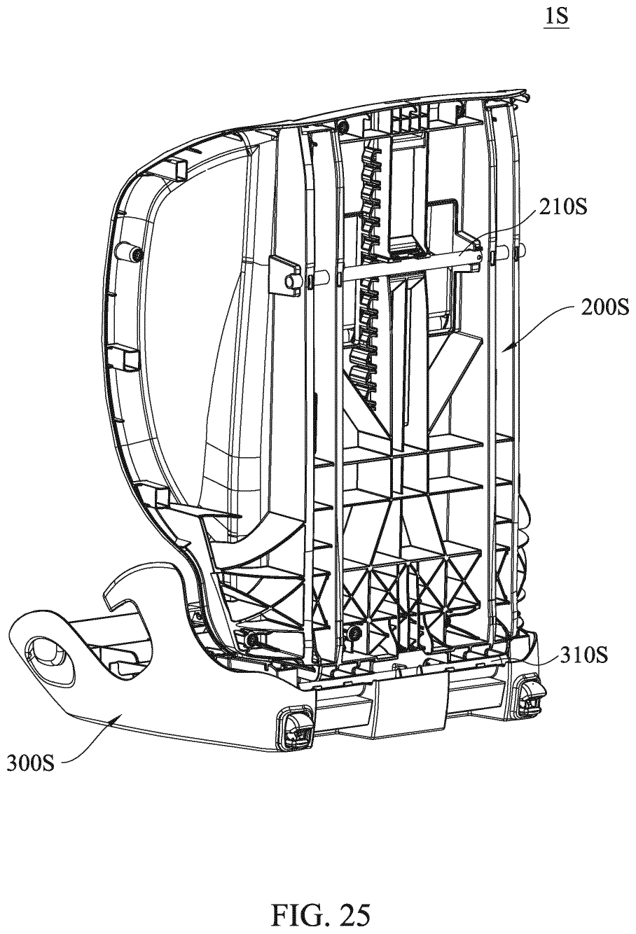

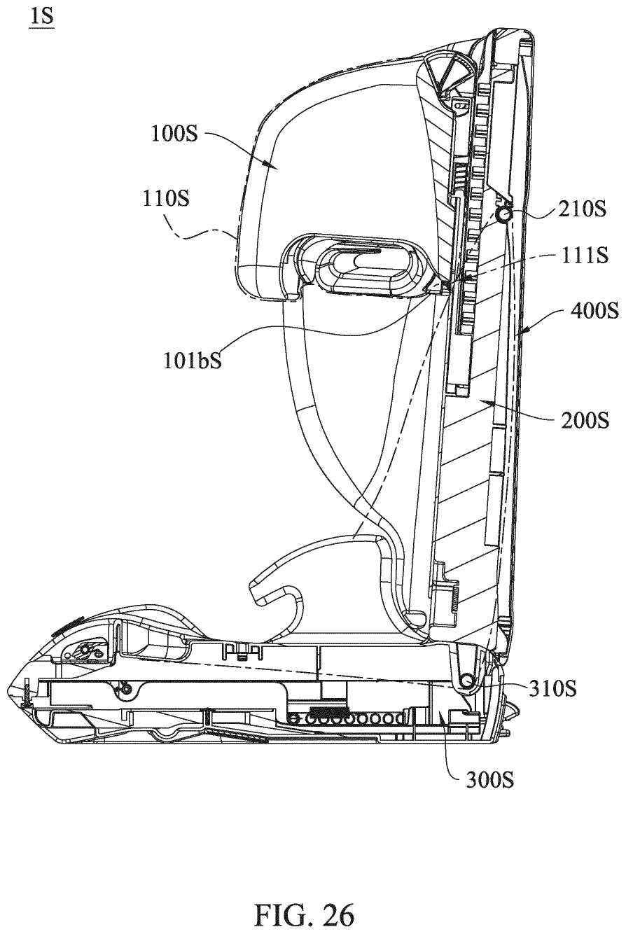

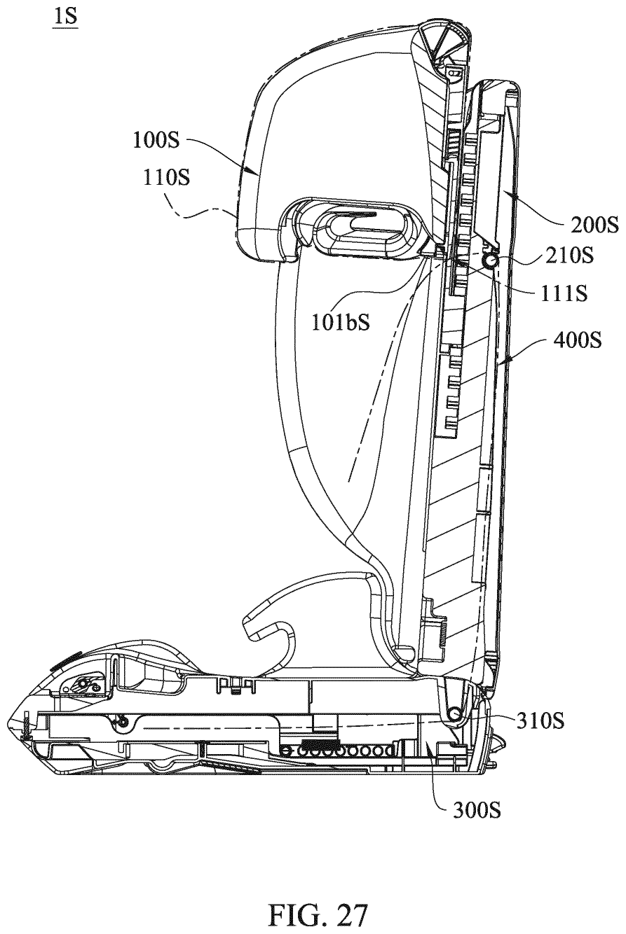

Referring to FIGS. 25 to 27, FIG. 25 shows a rear perspective view of the child safety seat IS shown in FIG. 22, and FIGS. 26 and 27 show sectional side views of the headrest portion 100S of the child safety seat 1S at different heights. Specifically, in FIG. 26, the headrest portion 100S is in the first position, and the first position may be the lowest position of the headrest portion 100S relative to the backrest portion 200S, as mentioned above. In FIG. 27, the headrest portion 100S is in a third position, and the third position is a critical position between a position where the child safety seat 1S of the present disclosure is suitable for being fixing by the five-point safety belt (i.e. “relatively low position”) and a position where the child safety seat IS of the present disclosure is suitable for being fixing by the vehicle safety belt (i.e. “relatively high position”).

First, as shown in FIGS. 26 and 27, the child safety seat 1S of the present disclosure is further provided with a safety belt 400S for five-point fixing. It should be noted that the safety belt 400S shown in the form of “dotted line” in the figure is only a schematic view for describing the arrangement of the safety belt 400S, and does not limit the shape and specific position of the safety belt 400S. Referring to FIGS. 25 to 27, the backrest portion 200S may be provided with a first turning portion 210S for the safety belt 400S to bypass and change an extending direction of the safety belt 400S (i.e., make the safety belt 400S turn).

In one embodiment, as shown in FIGS. 26 and 27, the safety belt 400S may extend upward the interior of the child safety seat 1S and from a lower part of the child safety seat 1S (e.g., from the interior of the seat portion 300S disposed below the backrest portion 200S), bypass the first turning portion 210S to change the extending direction, and continue to extend to the external of the front side of the child safety seat 1S, that is, extend out from the front side of the child safety seat 1S.

For example, as shown in FIG. 25, the first turning portion 210S may be fixedly disposed at a rear part of the backrest portion 200S, or may be a component disposed on the backrest portion 200S in an integrated manner, and be disposed at a non-top position of the backrest portion 200S. In one embodiment, the first turning portion 210S is disposed within a range of the height adjustment stroke of the headrest portion 100S relative to the backrest portion 200S. Preferably, the first turning portion 210S may be disposed at an approximate middle position of the height adjustment stroke, for example, approximatively at the middle of the length of the sliding groove 220S shown in FIG. 24.

Further, as shown in FIG. 26 and FIG. 27, when the headrest portion 100S is lower than the critical position, adjustment of the position of the headrest portion 100S is allowed, otherwise, the safety belt 400S will prevent the height adjustment of the headrest portion 100S relative to the backrest portion 200S. When the headrest portion 100S is below the critical position, the child safety seat 1 is suitable for fixing the child with the five-point safety belt arranged on it. On the other hand, when the headrest portion 100S is higher than or flush with the critical position, the child safety seat 1S is not suitable for fixing the child with the five-point safety belt, but is suitable for fixing the child with the vehicle safety belt.

In the present disclosure, the “critical position” may be determined by a position of the lower edge 101bS of the body 101S of the headrest portion 100S relative to the first turning portion 210S, that is, when the lower edge 101bS is flush with the first turning portion 210S, the headrest portion 100S is in the critical position. That is, when the lower edge 101bS of the headrest portion 100S is lower than the first turning portion 210S, adjustment of the position of the headrest portion 100S is allowed, otherwise, the safety belt 400S will prevent the height adjustment of the headrest portion 100S relative to the backrest portion 200S, that is, the headrest portion 100S is limited by the safety belt 400S and cannot be further adjusted upward. In addition, during the adjustment of the headrest portion 100S from a position shown in FIG. 26 to a position shown in FIG. 27, a shoulder belt part (of the safety belt 400S) extending out from the front side of the child safety seat 1S becomes longer, so that the child safety seat can be used by a child with a slightly larger size or height (and still suitable for fixing with the five-point safety belt).

In a specific example, a distance from the first turning portion 210S to the seat surface (e.g., a riding surface of the seat portion 300S) may be 370 mm to 430 mm. Preferably, the distance between the first turning portion 210S and the seat surface is 400 mm, which is the distance between the first turning portion 210S and the seat surface is a distance between the lower edge 101bS of the body 101S of the headrest portion 100S and the seat surface when the headrest portion 100S is in the critical position.

Preferably, as shown in FIG. 25, the first turning portion 210S may be provided as a rod, which may be horizontally disposed at the rear part of the backrest portion 200S. However, it should be understood that the first turning portion 210S of the present disclosure is not limited to the above-mentioned structure, and may be provided as a pin, a bump, a curved surface, and the like.

In an embodiment, the child safety seat 1S may further be provided with a second turning portion 310S. As shown in FIGS. 25 to 27, the second turning portion 310S may be disposed at the rear part of the seat portion 300S of the child safety seat 1S. By means of further providing the second turning portion 310S, the safety belt 400S can bypass the first turning portion 210S and the second turning portion 310S in turn, thus providing a better connection strength for the safety belt 400S.

Preferably, as shown in FIG. 25, the second turning portion 310S may be disposed as a bar horizontally arranged at the rear part of the seat portion 300S. However, it should be understood that the second turning portion 310S of the present disclosure is not limited to the above-mentioned structure, and may be disposed as a pin, a bump, a curved surface, and the like.

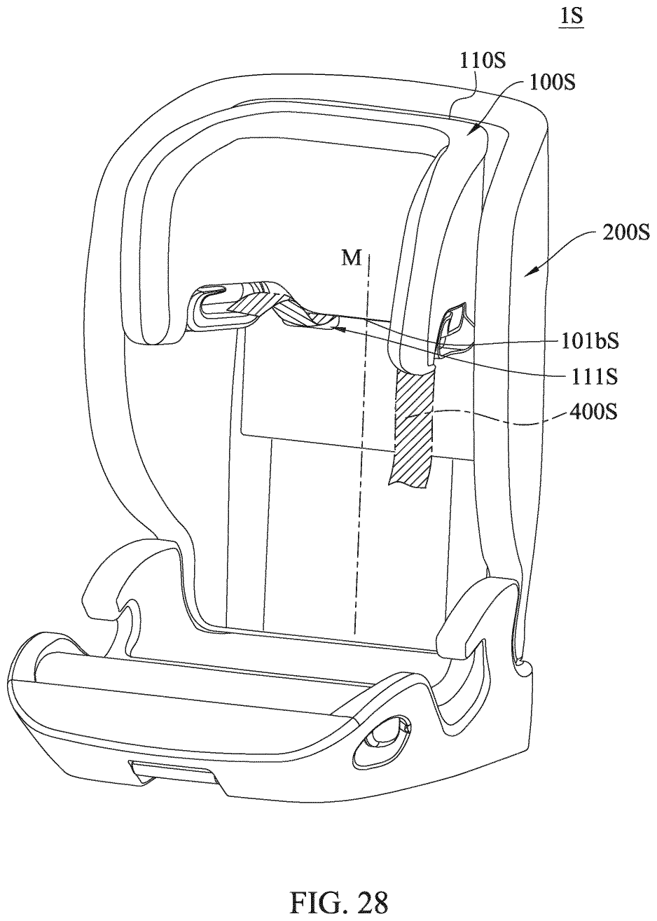

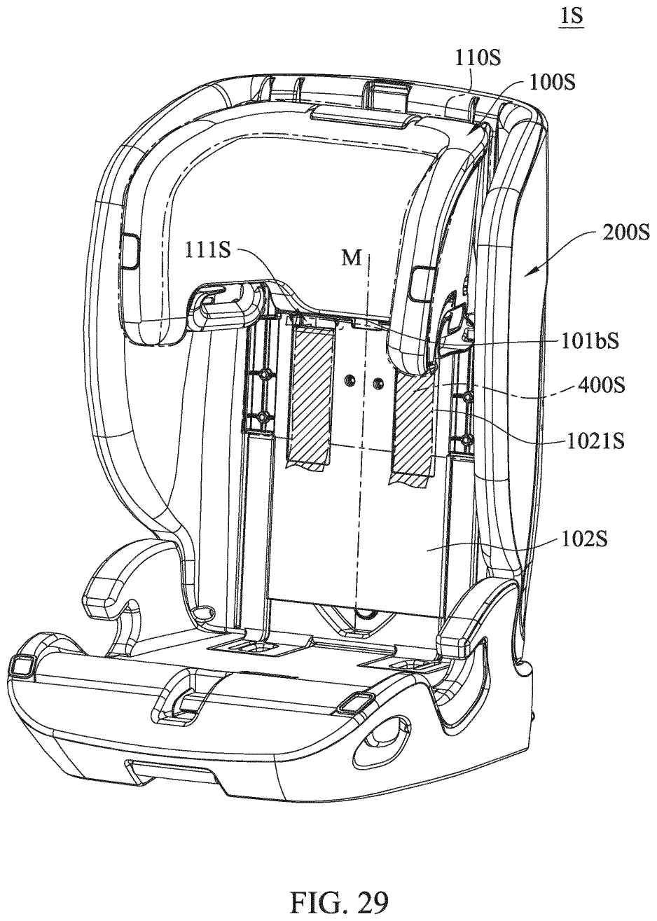

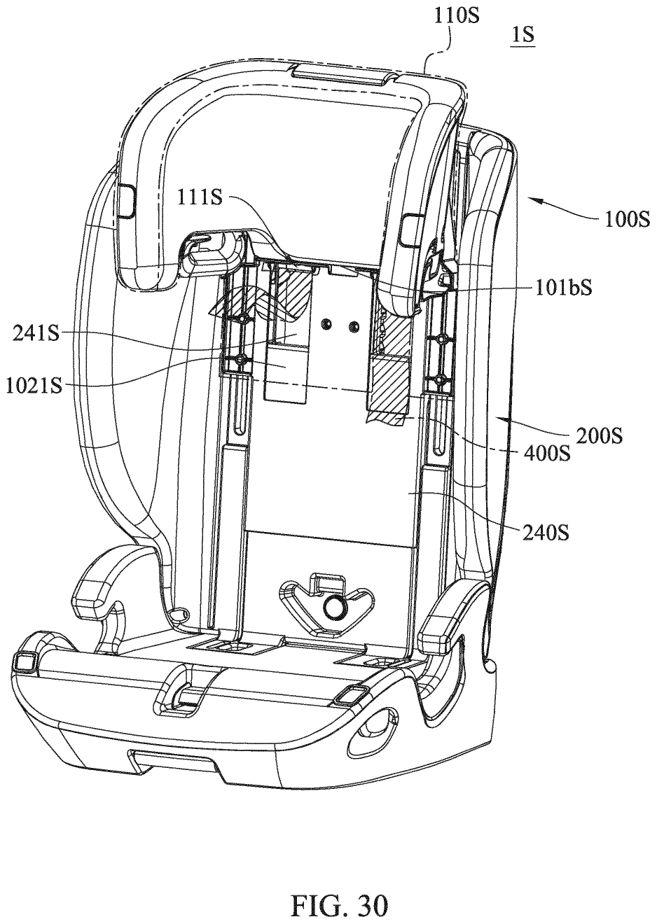

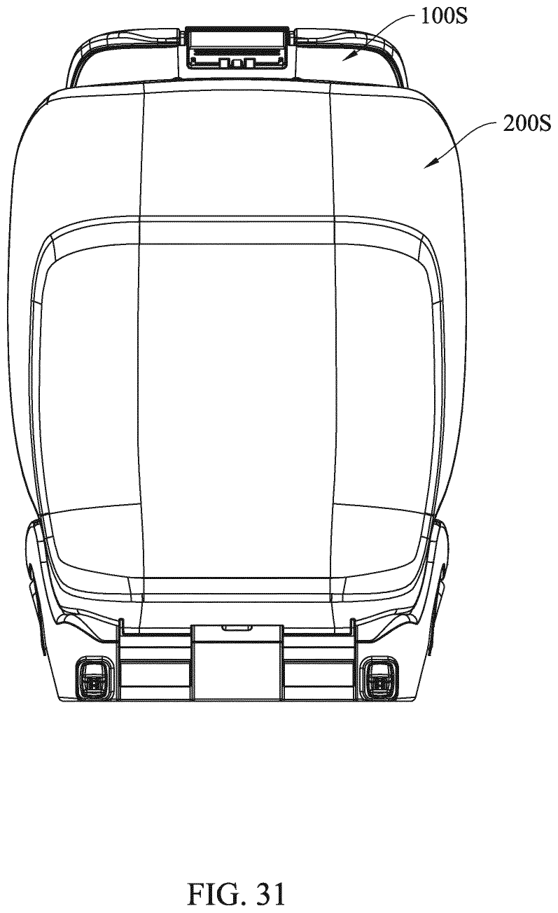

Further, referring to FIGS. 28 to 31, FIG. 28 shows an appearance schematic diagram showing the headrest portion 100S of the child safety seat IS shown in FIG. 26, which is covered with headrest covering cloth sleeved with a headrest covering cloth. FIGS. 29 and 30 show front perspective views of the child safety seats 1S shown in FIGS. 26 and 27, in which an arrangement of the safety belt 400S is also schematically shown. FIG. 31 shows a rear view of the child safety seat IS shown in FIG. 30. It should be noted that in FIGS. 29 and 30, a part of the safety belt 400S is schematically shown in a manner of “shadow”, and an outline of the headrest covering cloth 110S is schematically drawn in a manner of “dotted line”. The structure shown is only for convenience of explanation, and is not used to limit shapes, structures, and arrangements of the safety belt 400S and headrest covering cloth 110S of the present disclosure.

As shown in FIG. 29, the headrest portion 100S is provided with a first groove 1021S through which the safety belt 400S passes. For convenience of understanding, with regard to the first groove 1021S of the headrest portion 100S, reference may also be made to FIG. 32 shown later (i.e., a perspective view of the headrest portion 100S). As shown in FIG. 29 and FIG. 32, the first groove 1021S may be disposed on the connecting plate 102S and penetrate from a front surface to a rear surface of the connecting plate 102S. For example, the first groove 1021S may extend from an edge of the connecting plate 102S near the body 101S (i.e., from the lower edge 101bS of the body 101S) by a length smaller than a length of the connecting plate 102S. In one embodiment, two first grooves 1021S may be formed in the connecting plate 102S, and the two first grooves 1021S are symmetrically disposed with respect to the center line M of the connecting plate 102S. Of course, the present disclosure is not limited to this, and the first grooves 1021S may be disposed in other numbers or have other shapes and structures.

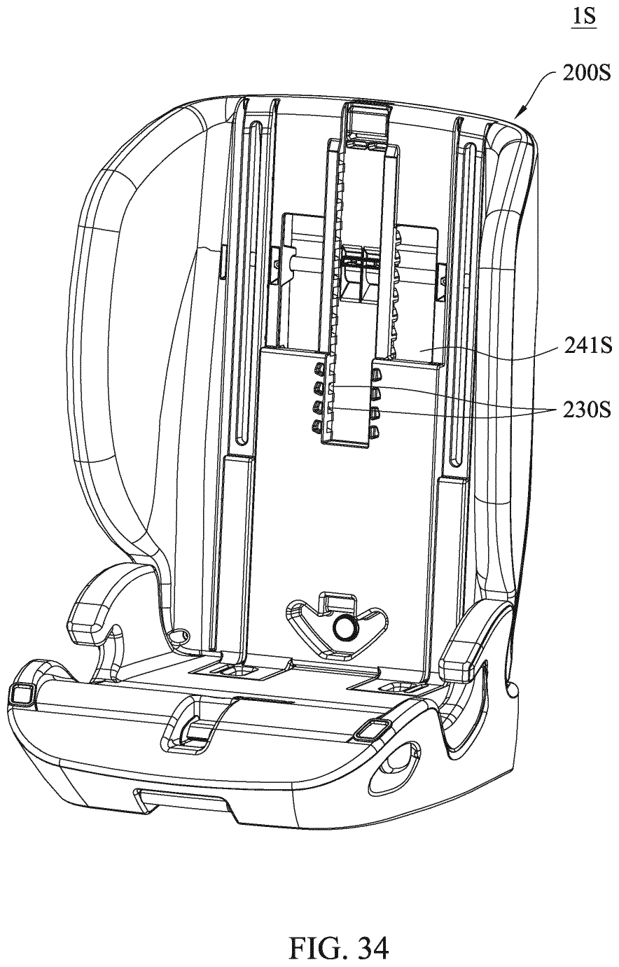

As shown in FIG. 30, the backrest portion 200S may be provided with a second groove 241S through which the safety belt 400S passes. For the convenience of understanding, with regard to the second groove 241S of the backrest portion 200S, reference may also be made to FIG. 34 shown later (i.e., a perspective view of the backrest portion 200S). With reference to FIGS. 30 and 34, the second groove 241S may be disposed on the back plate 240S of the backrest portion 200S, and generally corresponding to the first groove 1021S in a transverse direction (i.e., a left-right direction) of the child safety seat IS, so that when the headrest portion 100S is adjusted in height (i.e., in the vertical direction) with respect to the backrest portion 200S, at least a part of the first groove 1021S is always communicated to at least a part of the second groove 241S for safety belt 400S to pass through. In the embodiment where two first grooves 1021S are disposed on the connecting plate 102S, two second grooves 241S may be disposed on the backrest portion 200S correspondingly. Of course, the present disclosure is not limited to this, and the second groove 241S may be disposed in other numbers or have other shapes and structures.

The headrest portion 100S is configured such that when the headrest portion 100S slides within the height adjustment stroke of the headrest portion 100S relative to the backrest portion 200S, at least a part of the first groove 1021S coincides with the second groove 241S.

In one embodiment, as shown in FIG. 28, the headrest portion 100S is provided with a first groove 111S through which the safety belt 400S passes. For example, after the safety belt 400S extends out from the interior of the child safety seat IS, the safety belt 400S may pass through the first groove 111S to be adjusted accordingly with the change of the position of the headrest portion 100S relative to the backrest portion 200S. More specifically, as shown in FIGS. 28 to 30, a headrest covering cloth 110S is sleeved on the headrest portion 100S, and the headrest covering cloth 110S is fixedly connected to the headrest portion 100S. A first groove 111S is formed at a position of the headrest covering cloth 110S corresponding to the lower edge 101bS of the body 101S. The first groove 111S is roughly aligned with the top of the first groove 1021S, and always communicated with the second groove 241S during the adjustment of the headrest portion 100S, so that the safety belt 400S extends from a rear part of the child safety seat 1S to the external of the front side of the child safety seat 1S. For example, as can be seen from FIGS. 26 to 30, the safety belt 400S may sequentially bypass the second turning portion 310S and the first turning portion 210S, and pass through the first groove 111S to the external of the front side of the child safety seat 1S.

In one embodiment, the above-mentioned “critical position” may also be determined based on a position of the first groove 111S relative to the first turning portion 210S. Specifically, as shown in FIGS. 26 to 30, a position of the first groove 111S is set such that when the first groove 111S is lower than the first turning portion 210S (e.g., a position shown in FIG. 26), the safety belt 400S passing through the first groove 111S does not limit the height adjustment of the headrest portion 100S, until the first groove 111S is flush with the first turning portion 210S (e.g., a position shown in FIG. 27, i.e., the critical position), the safety belt 400S passing through the first groove 111S will limit the headrest portion 100S from further upward adjustment.

In other words, as shown in FIG. 26, when the lower edge 101bS of the headrest portion 100S is lower than the first turning portion 210S, a height of the shoulder belt part of the safety belt 400S is substantially at a height of the lower edge 101bS of the headrest portion 100S, which is suitable for a relatively small child to use a five-point safety belt mode. As shown in FIG. 27, after the lower edge 101bS of the headrest portion 100S is flush with the first turning portion 210S, if the upward adjustment is continued, the shoulder belt part of the safety belt 400S will pull the headrest covering cloth 110S, making it difficult or impossible for the headrest portion 100S fixedly connected to the headrest covering cloth 110S to be adjusted upward, which will prompt the user to place the safety belt 400S under the headrest covering cloth 110S (i.e., the safety belt 400S is not used for five-point fixing, and needs to be pulled out from the first groove 111S and received under the headrest covering cloth 110S), that is to say, the user is prompted to use a vehicle safety belt mode at this time.

In addition, it should be noted that in the above embodiment, the first groove 111S is disposed on the headrest covering cloth 110S, and the present disclosure is not limited to this, and the first groove 111S may also be disposed at other positions of the headrest portion 100S, such as the lower edge 101bS of the body 101S of the headrest portion 100S.

By means of the above arrangement, when the headrest portion 100S is adjusted to the critical position, the user will be prompted whether it is necessary to switch a mode of fixing the child, thus preventing a misuse of the five-point safety belt for a relatively large child, and further improving the user experience and use safety. Moreover, the disclosed structure is simple, and it is convenient to assemble, disassemble and maintain.

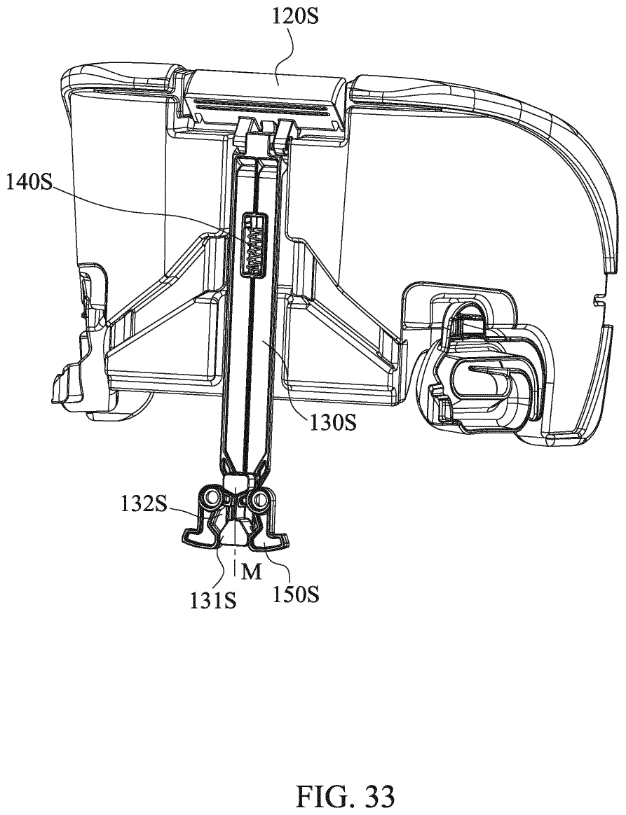

In addition, the child safety seat 1S may further be provided with a headrest height adjusting structure to adjust and fix the headrest portion 100S to different heights relative to the backrest portion 200S. Specifically, it will be described with reference to FIGS. 32 to 34. FIGS. 32 and 33 respectively show a perspective view of the headrest portion 100S and a perspective view of the headrest portion 100S with the connection plate 102S and a rear cover of the body 101S being removed (to show the internal structure), and FIG. 34 shows a perspective view of the child safety seat 1S with the headrest portion 100S being removed.

In one embodiment, as shown in FIGS. 32 and 33, the headrest height adjusting structure includes an operating element 120S, a driving element 130S and a locking element 150S. The operating element 120S is disposed on the headrest portion 100S, for example, pivotally disposed on an upper end of the headrest portion 100S. The driving element 130S is slidably connected to the headrest portion 100S, and an end of the driving element 130S is connected to the operating element 120S, for example, pivotally connected to the operating element 120S. The locking element 150S is located at the other end of the driving element 130S and is used for locking or unlocking a position of the headrest portion 100S relative to the backrest portion 200S. In one embodiment, as shown in FIG. 32, the locking element 150S can be pivotally connected to the headrest portion 100S, for example, to the connecting plate 102S of the headrest portion 100S.

In a preferred embodiment, the operating element 120S, the driving element 130S and the locking element 150S may be symmetrically disposed about the center line M of the connecting plate 102S. In a specific example, when two first grooves 1021S are symmetrically disposed on the connecting plate 102S, the driving element 130S and the locking element 150S may be located between the two first grooves 1021S.

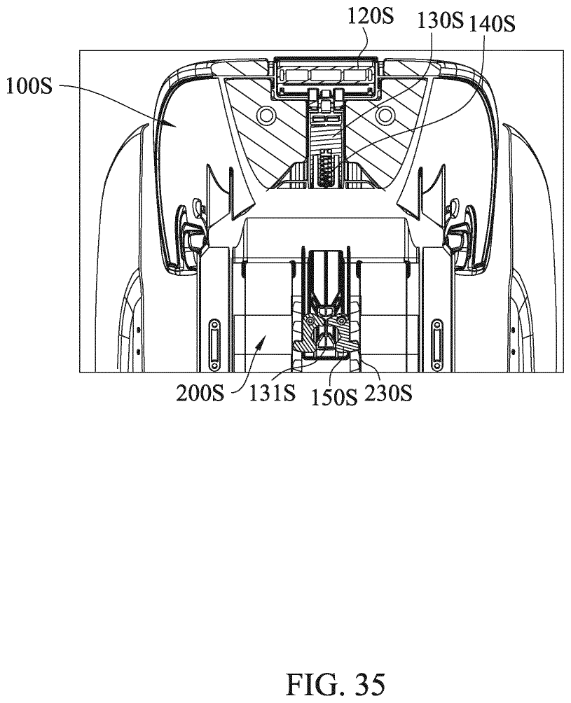

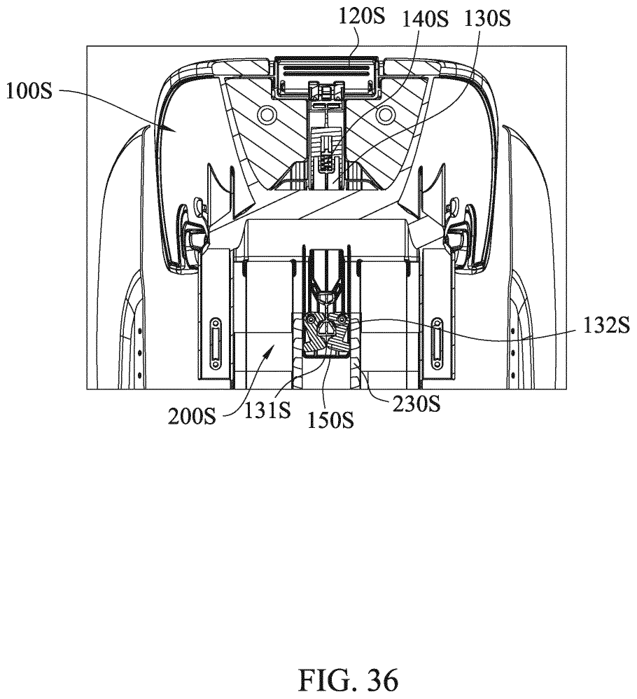

Referring to FIG. 32 and FIG. 34, the locking element 150S can cooperate with one of several adjusting grooves 230S on the backrest portion 200S, to be switched between a locking position and an unlocking position, so that the position of the headrest portion 100S relative to the backrest portion 200S is locked or unlocked. The “locking position” and “unlocking position” will be described in detail below with reference to FIGS. 35 and 36.

In a specific example, as shown in FIG. 32, the locking element 150S may be a hook assembly. The hook assembly is pivotally connected to the headrest portion 100S, for example, to the connecting plate 102S, to be engaged with a corresponding adjusting groove 230S on the backrest portion 200S shown in FIG. 34, thereby locking the position of the headrest portion 100S relative to the backrest portion 200S. As shown in FIG. 34, the adjusting groove 230S is disposed at intervals along a sliding direction of the headrest portion 100S relative to the backrest portion 200S, to position the headrest portion 100S at different positions relative to the backrest portion 200S. Preferably, the hook assembly may include a pair of hooks, which are symmetrically disposed with respect to the center line M of the headrest portion 100S, and can be relatively pivoted synchronously by operating or releasing the operating element 120S, to be engaged with the corresponding adjusting groove 230S. In this embodiment, the hook may adopt an L-shaped structure, and may pivot outward relative to the center line M of the headrest portion 100S to realize locking, or pivot outward to realize unlocking. However, it should be understood that the hook may also adopt other structures, and even the locking element 150S may take on or include other shapes, such as retractable pins, etc., which is not limited by the present disclosure.

In addition, as shown in FIG. 33, the headrest height adjusting structure further includes a restoring spring 140S. The restoring spring 140S is disposed between the driving element 130S and the headrest portion 100S and configured to drive the driving element 130S to resist the operation of the operating element 120S, so that the locking element 150S always tends to return or remain in the locking position. For example, the restoring spring 140S may provide a force to move the driving element 130S downward, so as to restore or maintain the hook to pivot outward, so as to be engaged with the corresponding adjusting groove 230S (please refer to the following FIG. 35).

In an embodiment, as shown in FIG. 33, the other end (i.e., an end corresponding to the locking element 150S, e.g., a lower end) of the driving element 130S is provided with an abutting portion 131S, and is held in contact with the locking element 150S. As shown in FIG. 35, when the headrest portion 100S is locked, the driving element 130S enables the abutting portion 131S to be held in a position where the abutting portion 131S abuts against the locking element 150S under an action of the restoring spring 140S. Specifically, as shown in FIG. 33, in the embodiment in which the locking element 150S is a pair of hooks, the abutting portion 131S is in a configuration that a dimension gradually changes (e.g., gradually increases) toward an end of the locking element 150S, and an accommodating space 132S matching a shape of the abutting portion 131S is formed between the hooks, so that a movement of the abutting portion 131S relative to the pair of hooks (e.g., applying an abutting force to the pair of hooks or releasing the abutting force) can drive the pair of hooks to pivot towards or against each other, and the specific principle can be further referred to the description in combination with FIGS. 35 and 36.

For this reason, the working principle of the headrest height adjusting structure will be explained in detail with a specific example in combination with FIGS. 35 and 36.

Referring to FIGS. 35 and 36, FIG. 35 shows a state in which the headrest portion 100S is locked relative to the backrest portion 200S, that is, the locking element 150S is in the locking position. FIG. 36 shows a state in which the headrest portion 100S is unlocked relative to the backrest portion 200S, that is, the locking element 150S is in the unlocking position.

As shown in FIG. 35, when the headrest portion 100S is in a locked state, the driving element 130S is held in a lower position under the action of the restoring spring 140S. Here, the abutting portion 131S disposed at a lower end of the driving element 130S is held in a position where the abutting portion 131S abuts against a pair of hooks of the locking element 150S on both sides of the abutting portion 131S, so that the pair of hooks are respectively engaged with the corresponding adjusting grooves 230S disposed on the backrest portion 200S, that is, the locking elements 150S is in the locking position.

When it is necessary to adjust the headrest portion 100S, as shown in FIG. 36, the operating element 120S is pressed, and the operating element 120S drives the driving element 130S to move upward against an elastic force of the restoring spring 140S, so that the abutting portion 131S at the lower end of the driving element 130S moves upward, and at this time, the abutting portion 131S no longer abuts against the hooks on both sides thereof, so that the pair of hooks may pivot toward each other following an outer contour of the abutting portion 131S, to be disengaged from the corresponding adjusting groove 230S (i.e., the locking element 150S is switched from the locking position to the unlocking position) until the abutting portion 131S is completely accommodated in the accommodating space 132S formed between the pair of hooks. At this time, the headrest portion 100S is unlocked (in the unlocked state), so that the position of the headrest portion 100S relative to the backrest portion 200S can be adjusted.

When the headrest portion 100S is adjusted to an appropriate position, the operating element 120S is released, and the driving element 130S moves downward under the action of the restoring spring 140S, thereby driving the locking element 150S to return from the unlocking position to the locking position, that is, the position shown in FIG. 35, so that the headrest portion 100S can return to the locked state again.

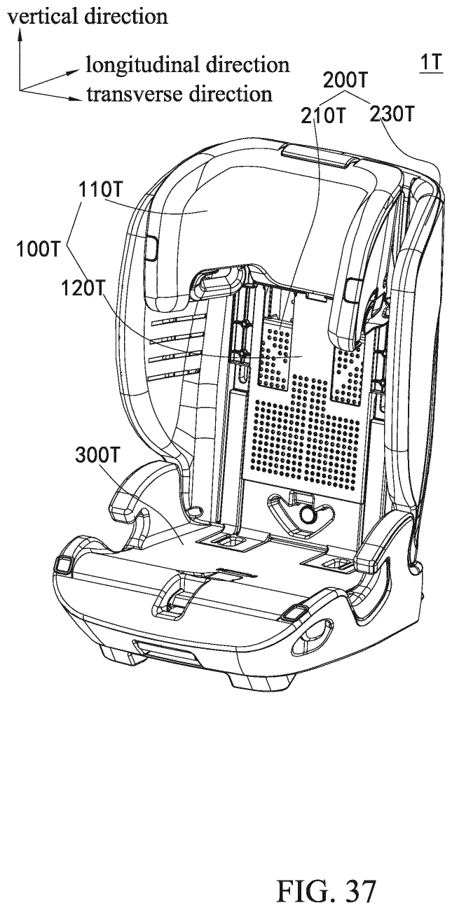

A child safety seat 1T according to the present disclosure is described with reference to FIGS. 37 to 39. The child safety seat 1T includes a headrest portion 100T, a backrest portion 200T and a seat portion 300T.

The seat portion 300T is located at a bottom end (a vertical lower end) of the child safety seat 1T, and substantially extends in a transverse direction and a longitudinal direction. The backrest portion 200T is connected to a longitudinal rear end of the seat portion 300T and substantially extends in a vertical direction. In one embodiment, the backrest portion 200T is detachably connected to the seat portion 300T, which will be described in detail later. The headrest portion 100T is connected to a front side of the backrest portion 200T and substantially extends in the vertical direction. The headrest portion 100T is connected to the backrest portion 200T through a connecting component (not shown) such as a guide rail or a sliding block to allow the headrest portion 100T to move in the vertical direction relative to the backrest portion 200T. The sliding connection between the headrest portion 100T and the backrest portion 200T may adopt the prior art in the field, and the detailed description thereof is omitted herein.

The headrest portion 100T may include a buffer portion 110T and a board portion 120T. The buffer portion 110T is in a vertical upper part of the headrest portion 100T, and the buffer portion 110T is made of or covered with soft materials to protect the head of the child. In one embodiment, the material of the buffer portion 110T may be expanded polystyrene (EPS) or expanded polypropylene (EPP) and other materials. The board portion 120T is located at a vertical lower part of the headrest portion 100T, and is a substantially flat plate extending vertically and horizontally.

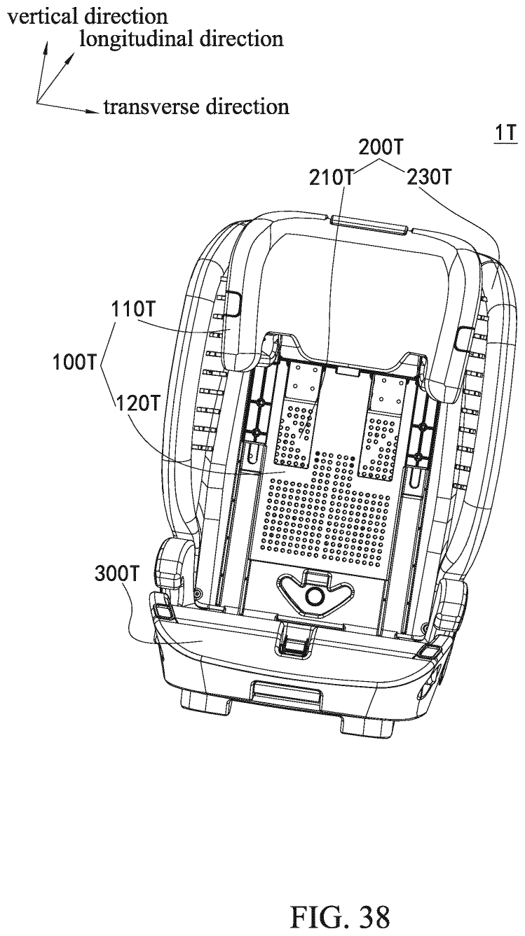

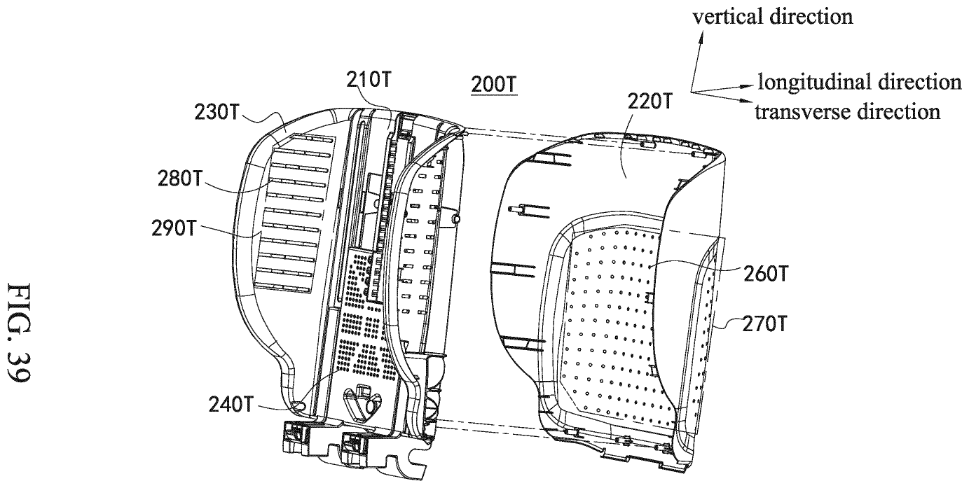

Referring to FIG. 39, FIG. 39 is an exploded perspective view of the backrest portion of the child safety seat according to the present disclosure. The backrest portion 200T may include a front cover 210T and a rear cover 220T. The front cover 210T and the rear cover 220T may be attached to each other. It should be noted that the front cover 210T and the rear cover 220T are not closely attached to each other. In other words, there is a gap between the front cover 210T and the rear cover 220T. As shown in FIGS. 37 and 38, the board portion 120T of the headrest portion 100T may be contact or abut against a front side of the front cover 210T. The backrest portion 200T may further include at least one side wing 230T. The side wing 230T extends forward from a transverse side of the front cover 210T in the longitudinal direction to provide a better protection for the child. In this embodiment, the left and right sides of the backrest portion 200T are provided with side wings 230T. In addition, both sides of the rear cover 220T may also extend forward to cover the side wings 230T.

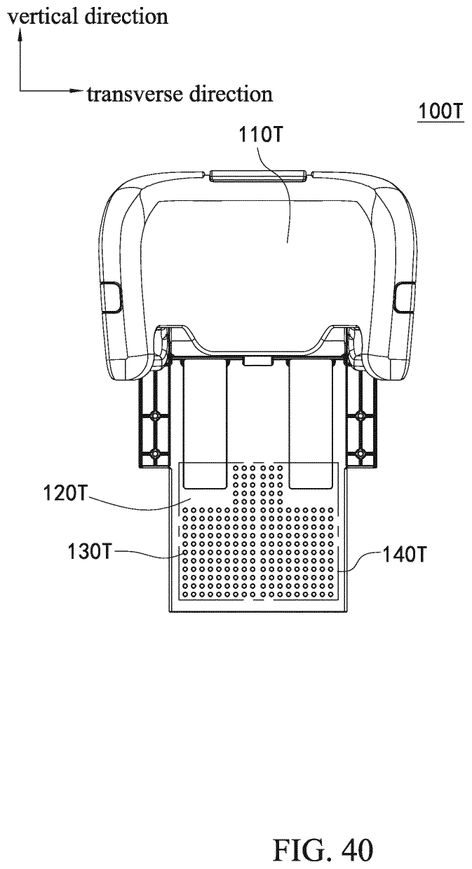

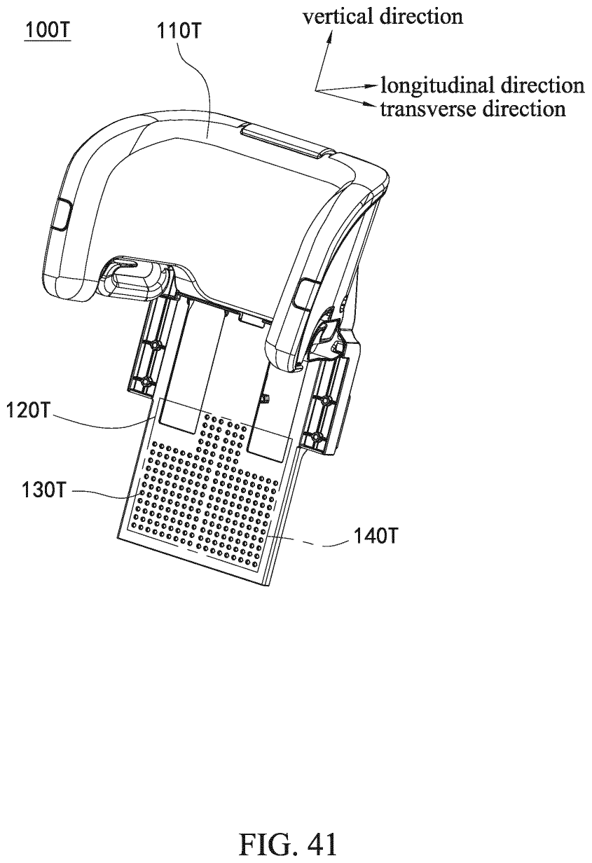

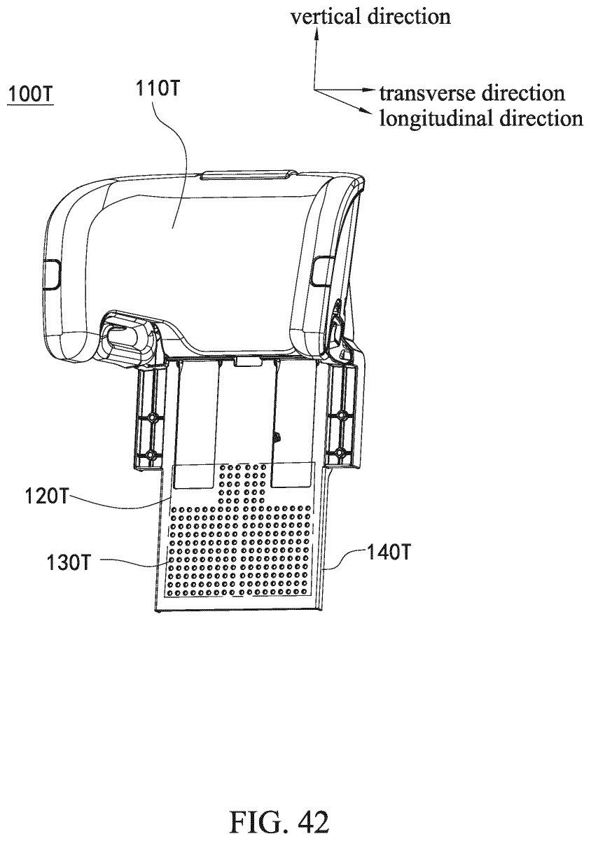

The headrest portion 100T will be described in detail with reference to FIGS. 40 to 42.

In this embodiment, the left and right sides of the buffer portion 110T extend forward, so that the entire buffer portion 110T has a U-shaped cross section in the transverse direction, thereby providing a better safety protection for a child's head. In other embodiments, the buffer portion 110T may have other appropriate shapes.

The board portion 120T is provided with one or more first vents 130T. The first vent 130T penetrates the board portion 120T in the longitudinal direction (a direction perpendicular to the vertical direction and the transverse direction). A plurality of first vents 130T may be arranged in different patterns. In this embodiment, a plurality of first vents 130T are arranged in the transverse direction and the vertical direction, thus forming a rectangular array. In other embodiments, the first vents 130T may also be arranged in other ways, such as a circular arrangement and a staggered arrangement.

In this embodiment, each first vent 130T is in a circular shape. In other embodiments, the first vents 130T may be in other shapes, such as a square shape, a triangle shape, a straight line shape, a curved line shape, and may have other dimensions. In one embodiment, the maximum diameter of each first vent 130T may fall outside a range of 5 mm to 12 mm. That is, the maximum diameter of each first vent 130T may be less than or equal to 5 mm or more than 12 mm to prevent a child's fingers from being inserted into the first vent 130T.

In this embodiment, an upper half of the board portion 120T is provided with a rectangular structural hole (e.g., for installing the slide rail or the safety belt), so the first vents 130T are mainly distributed in a lower half of the board portion 120T, that is, the first vent region 140 shown by a dashed box in FIGS. 40 to 42. In other embodiments, the first vents 130T may be distributed in various regions of the board portion 120T. The first vent region 140T is closer to an end of the board portion 120T away from the buffer portion 110T.

In one embodiment, a total area of the first vents 130T may be 50% to 70% of an area of the board portion 120T, which can give consideration to both air permeability and strength of the child safety seat 1T. Therefore, considering an overall strength of the child safety seat 1T, the first vents 130T can still provide good air permeability.

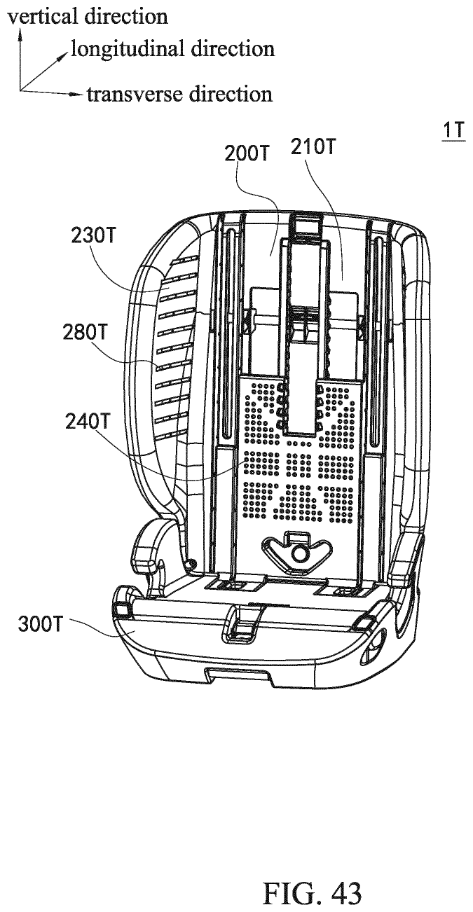

The backrest portion 200T will be described in detail with reference to FIGS. 43 to 45.

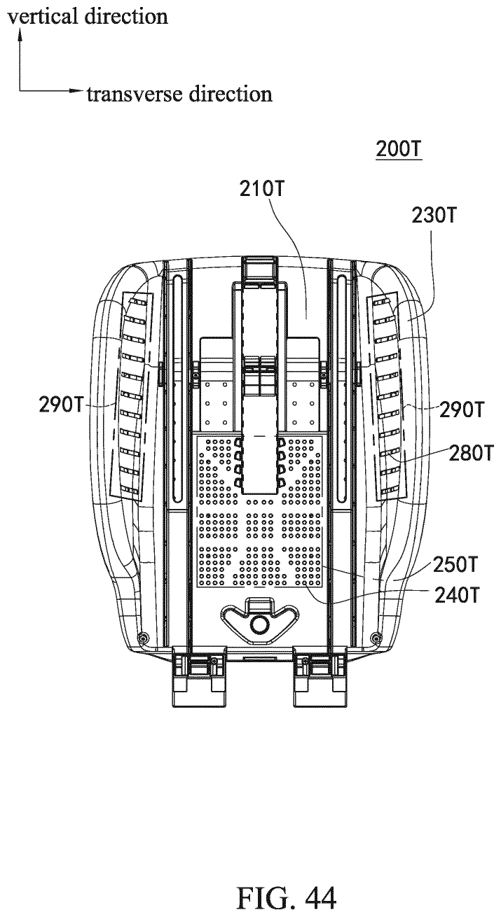

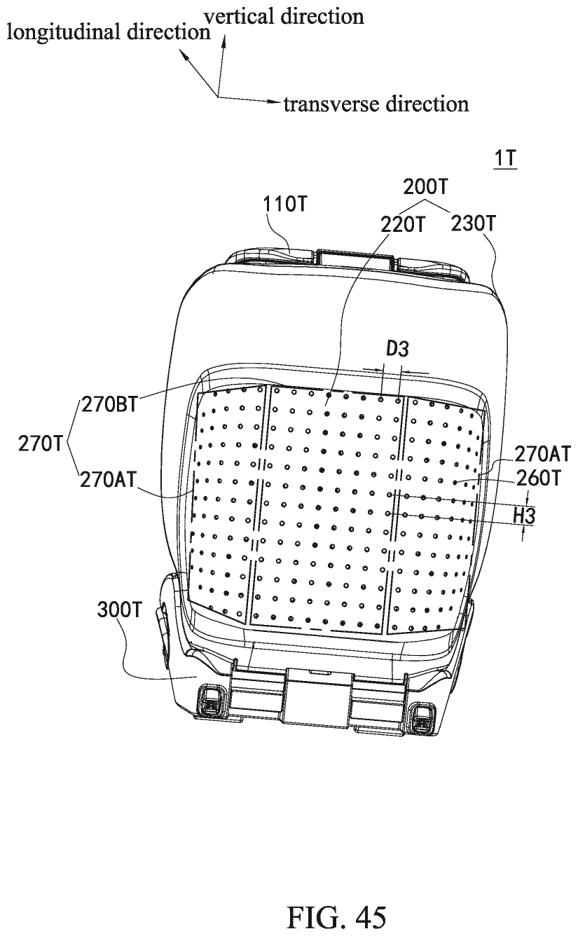

In this embodiment, the backrest portion 200T is formed by assembling the front cover 210T and the rear cover 220T (see FIGS. 44 and 45). In other embodiments, the backrest portion 200T may also be an integral component including the features of the front cover 210T and the rear cover 220T.

As shown in FIGS. 43 and 44, the front cover 210T is provided with second vents 240T, and each second vent 240T penetrates the front cover 210T in the longitudinal direction.

In this embodiment, a plurality of second vents 240T may also be arranged in different patterns. In this embodiment, a plurality of second vents 240T are arranged in the transverse direction and the vertical direction, thus forming a rectangular array. In other embodiments, the second vents 240T may also be arranged in other ways, such as a circular arrangement and a staggered arrangement.

In this embodiment, each second vent 240T is in a circular shape. In other embodiments, the second vent 240T may be in other shapes, such as a square shape, a triangle shape, a straight line shape, a curved line shape, and may have other dimensions. The maximum diameter of each second vent 240T may fall outside the range of 5 mm to 12 mm. That is, the maximum diameter of each second vent 240T may be less than or equal to 5 mm or more than 12 mm to prevent a child's fingers from being inserted into the second vent 240T. In this embodiment, the second vents 240T are mainly distributed in a lower half of the front cover 210T, that is, a second vent region 250T shown by a dashed box in FIG. 44. In this way, when the headrest portion 100T slides along the backrest portion 200T, the first vent region 140T and the second vent region 250T at least partially overlap, so that at least one first vent 130T is communicated with at least one second vent 240T, which will be described in detail below. In other embodiments, the second vents 240T may be distributed in various regions of the front cover 210T as long as they can be communicated with the first vents 130T. Specifically, a center position of at least one first vent 130T and a center position of at least one second vent 240T may be aligned with each other in the longitudinal direction, or slightly staggered, so that at least one first vent 130T and at least one second vent 240T are completely or partially communicated, preferably completely communicated.

In one embodiment, a total area of the second vents 240T may be 30% to 50% of an area of the front cover 210T. Therefore, the second vent 240T provides good air permeability.

The side wings 230T are disposed on at least one transverse side of the front cover 210T and extend in the vertical direction and the longitudinal direction. In this embodiment, both sides of the front cover 210T are provided with the side wing 230T, and the side wing 230T substantially has the same vertical dimensions as the front cover 210T. As shown in FIG. 44, each side wing 230T is provided with at least one fourth vent 280T. In this embodiment, the fourth vent 280T is elongated in the longitudinal direction, and a plurality of fourth vents 280T are vertically arranged in the fourth vent region 290T to form a substantially rectangular pattern. In this embodiment, a total area of the fourth vent 280T on each side wing 230T is 50% to 80% of an area of the side wing 230T, which can give consideration to the structural strength and air permeability of the side wing 230T. Therefore, the side wings 230T provide additional air permeability.

As shown in FIG. 45, the rear cover 220T is attached to a longitudinal rear of the front cover 210T, and the rear cover 220T is provided with at least one third vent 260T.

In this embodiment, a plurality of third vents 260T may also be arranged in different patterns. In this embodiment, a plurality of third vents 260T are arranged in the transverse direction and the vertical direction, thus forming a rectangular array. In other embodiments, the third vents 260T may also be arranged in other ways, such as a circular arrangement and a staggered arrangement.

In this embodiment, each third vents 260T is in a circular shape. In other embodiments, the third vents 260T may be in other shapes, such as a square shape, a triangle shape, a straight line shape, a curved line shape, and may have other dimensions. The maximum diameter of each third vent 260T may fall outside the range of 5 mm to 12 mm. That is, the maximum diameter of each third vent 260T may be less than or equal to 5 mm or more than 12 mm to prevent a child's fingers from being inserted into the third vent 260T.

In this embodiment, the third vents 260T are mainly distributed in a lower half and middle part of the rear cover 220T, that is, the third vent region 270T shown by a dashed box in FIG. 45. There may be a gap between the front cover 210T and the rear cover 220T, so gas may flow between the front cover 210T and the rear cover 220T through the gap, so that the gas flowing through the second vent 240T is exhausted through the third vents 260T. The second vent region 250T does not necessarily correspond to the third vent region 270T. For example, referring to FIG. 44 and FIG. 45, the third vent region 270T may be larger than the second vent region 250T.

As shown in FIG. 45, in this embodiment, the third vent region 270T may be divided into two surrounding regions 270AT arranged along the transverse direction and a middle region 270BT located between the two surrounding regions 270AT. A location of the middle region 270BT corresponds to that of the second vent region 250T of the front cover 210T, and overlaps with the second vent region 250T by at least 60%. Locations of the surrounding regions 270AT are staggered (i.e., overlap partially or not at all) with the position of the second vent region 250T. For example, an overlapping area ratio of either of surrounding regions 270AT and the second vent region 250T may be less than 50%.

In this embodiment, a distribution density of the third vents 260T in the middle region 270BT is substantially the same as a distribution density of the third vents 260T in either of surrounding regions 270AT, but the present disclosure is not limited to this. The above distribution density can be defined as the number of the third vents 260T per unit area or a total area of the third vents 260T per unit area.

It is worth mentioning that the front cover 210T and the rear cover 220T are not closely attached to each other. In other words, there is a gap between the front cover 210T and the rear cover 220T. Therefore, it is not necessary for the first vent region 140T or the second vent region 250T to overlap with the third vent region 270T to form an airflow channel. In some applications, when the child safety seat 1 is disposed on a vehicle, a middle region 270BT of the rear cover 220T will be closely attached to the seat of the vehicle, so that the airflow is mainly exhausted by the third vents 260T distributed in the surrounding region 270AT.

Accordingly, in one embodiment, a distribution density of the third vents 260T in the surrounding region 270AT may be greater than a distribution density of the third vents 260T in the middle region 270BT, and the overall air permeability of the child safety seat IT can be improved without excessively reducing the structural strength of the rear cover 220T.

In addition, referring to FIG. 39 and FIG. 43, in this embodiment, the rear cover 220T has parts extending forward from both sides thereof to cover the side wings 230T. However, the rear cover 220T does not need to be provided with vents corresponding to the fourth vents 280T. The gas may flow between the side wing 230T and the rear cover 220T via the gap between the front cover 210T and the rear cover 220T, so that the gas flowing through the fourth vent 280T is exhausted through the third vents 260T.

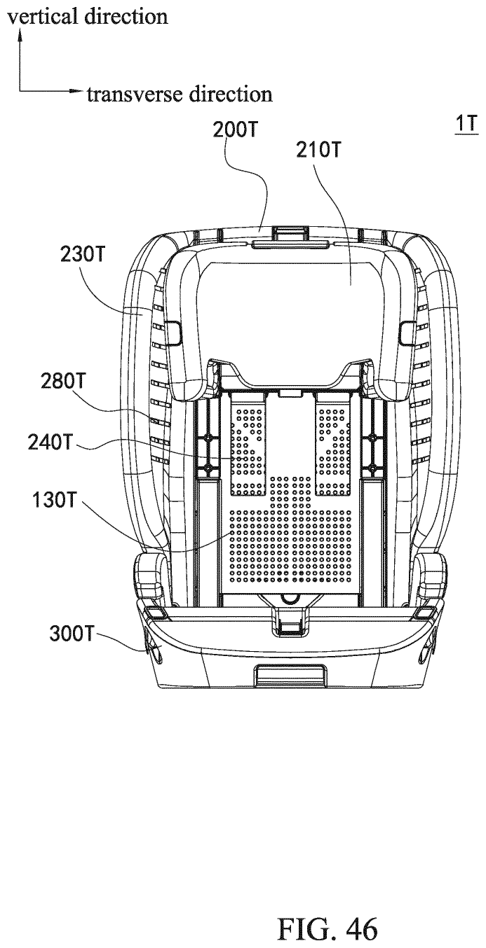

A movement of the headrest portion 100T relative to the backrest portion 200T will be described with reference to FIGS. 46 to 49.

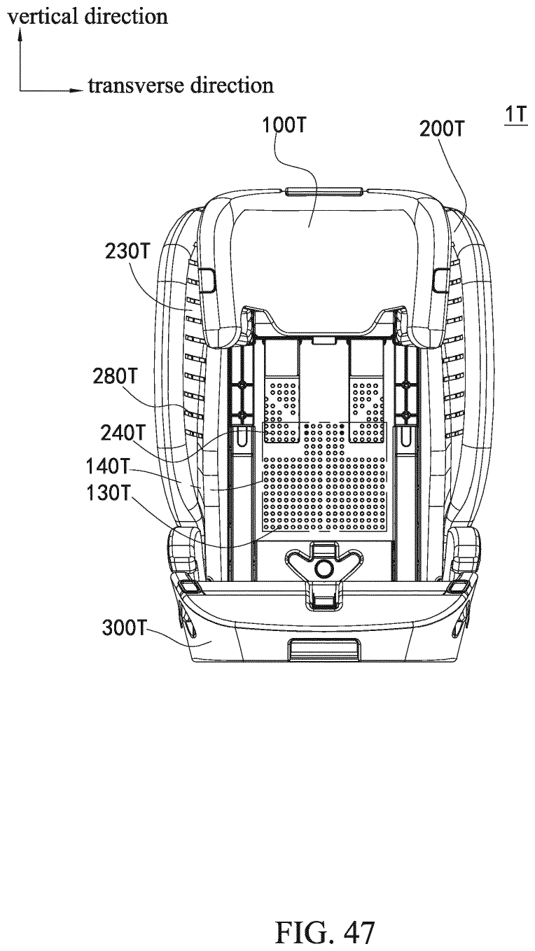

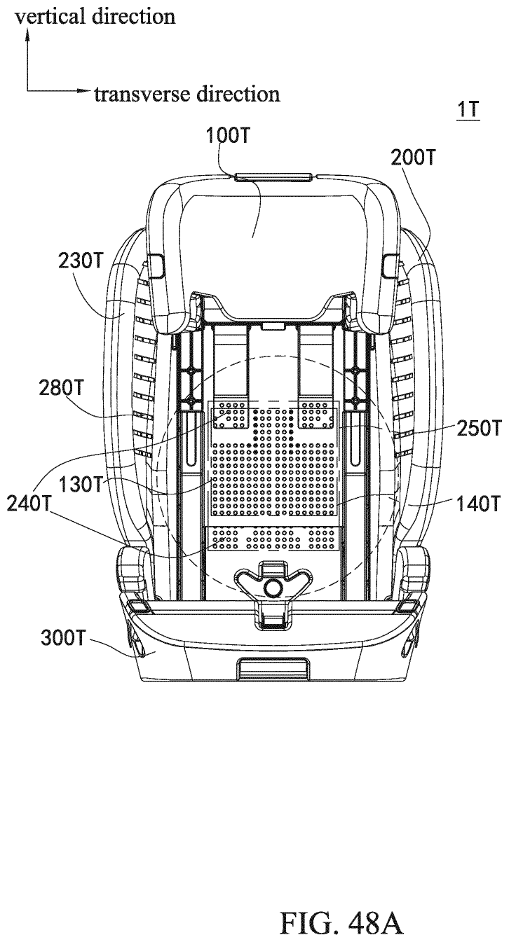

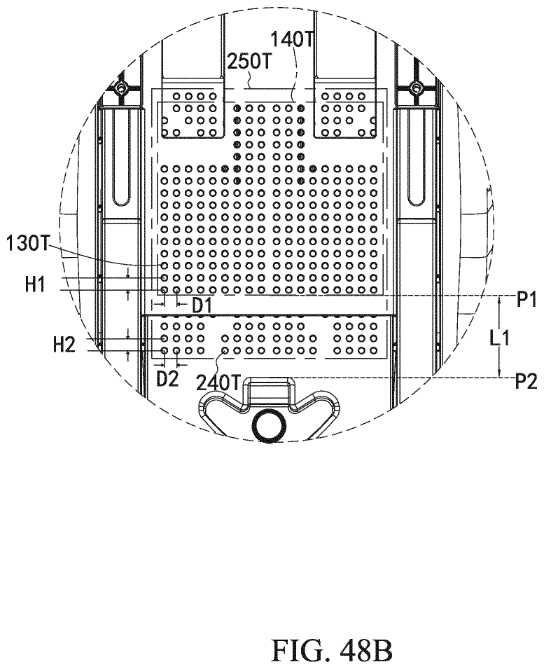

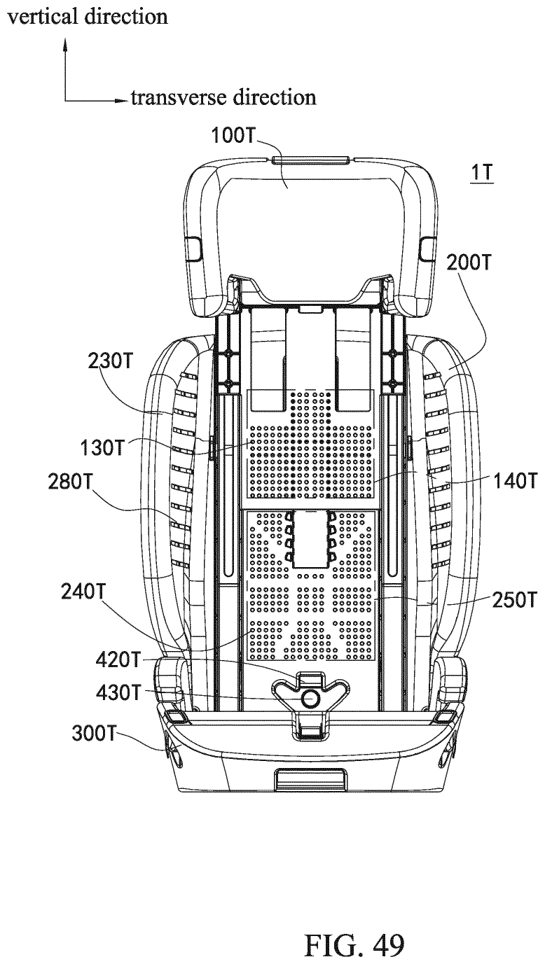

The headrest portion 100T (specifically the board portion 120T) can slide along a path relative to the back. In the present disclosure, the path is a longitudinal path, that is, a substantially vertical straight line. FIG. 46 shows a case that the headrest portion 100T slides to the lowest position. FIGS. 47 and 48A show cases that the headrest portion 100T slides to different intermediate positions. FIG. 49 shows a case that the headrest portion 100T slides to the highest position.

The board portion 120T can be held in at least one position in the sliding path, for example, the positions shown in FIGS. 46 to 49 may respectively correspond to different positions. The board portion 120T may be held at a desired position by techniques known in the art, and detailed description thereof is omitted herein.

In an embodiment of the present disclosure, when the board portion 120T is in a position where the first vent region 140T and the second vent region 250T overlap with each other, an overlapping area of the plurality of first vents 130T and the plurality of second vents 240T is at least 20%, preferably 20% to 50% of the area of the board portion 120T. That is, at least one first vent 130T is communicated with at least one second vent 240T when the board portion 120T is located at each position except at the highest position. For example, in a position shown in FIG. 46, a plurality of first vents 130T are communicated with a plurality of lower second vents 240T among the second vents 240T. For example, at the positions shown in FIGS. 47 and 48A, a plurality of first vents 130T are communicated with a plurality of middle second vents 240T among the second vents 240T.

Referring to FIG. 48B, it can be seen that the first vent region 140T and the second vent region 250T substantially have the same width (transverse dimension).

In this embodiment, a vertical distance H1 between adjacent first vents 130T may be less than or equal to a vertical distance H2 between adjacent second vents 240T. A horizontal distance D1 between adjacent first vents 130T may be less than or equal to a horizontal distance D2 between adjacent second vents 240T. In this way, when the headrest portion 100T (or the board portion 120T) stops at any position and the first vent region 140T at least partially overlaps with the second vent region 250T, as many first vents 130T as possible are allowed to be communicated with the second vents 240T. Therefore, the gas in front of the headrest portion 100T may directly flow to the rear of the front cover 210T via the first vents 130T and the second vents 240T, forming an improved exhaust system. It should be noted that in this embodiment, a maximum diameter of the second vent 240T is greater than or equal to a maximum diameter of the first vent 130T. Preferably, the maximum diameter of the second vent 240T is larger than the maximum diameter of the first vent 130T, which can reduce the flow resistance of gas, and make the gas in front of the headrest portion 100T smoothly pass through the first vents 130T and the second vents 240T, and then flow to the rear of the front cover 210T, thus improving the permeability effect.

Because the first vent region 140T of the board portion 120T of the headrest portion 100T is mainly used to support the waist or back of the passenger, it is necessary for the first vent region 140T to have certain structural strength to avoid the deformation of the board portion 120T due to insufficient structural strength when adjusting the position of the headrest portion 100T. Accordingly, in this embodiment, the maximum diameter of the first vents 130T located in the first vent region 140T is preferably less than or equal to 5 mm, and the distribution density of the first vents 130T in the first vent region 140T may be greater than the distribution density of the second vents 240T in the second vent region 250T, so that the permeability effect can be improved while maintaining the structural strength of the board portion 120T.

The distribution density of the first vents 130T may be defined as the number of the first vents 130T per unit area or the total area of the first vents 130T per unit area within the range of the first vent region 140T. Similarly, the distribution density of the second vents 240T may be defined as the number of the second vents 240T per unit area or the total area of the second vents 240T per unit area within the range of the second vent region 250T.

In addition, referring to FIG. 47, FIG. 48A and FIG. 48B, in this embodiment, a bottom end of the board portion 120T is located at a height position P1 and a height position P2 respectively in adjacent two positions. A vertical distance between the two height positions P1, P2 may be defined as a moving stroke L1 of the headrest portion 100T (or the board portion 120T) in two adjacent positions. In this embodiment, the moving stroke L1 of the board portion 120T may be an integer multiple of the vertical distance H2 between adjacent second vents 240T. That is, the following relationship may be satisfied between the moving stroke L1 and the vertical distance H2 between the adjacent second vents 240T: L1=N*H2, where n is a positive integer greater than or equal to 1. In this way, a shift of the position of the headrest portion 100T (or the board portion 120T) will not cause the plurality of first vents 130T and the plurality of second vents 240T to be misaligned with each other. When the headrest portion 100T is in different positions, it can be ensured that at least a part of the first vents 130T and at least a part of the second vents 240T are aligned and communicated with each other, and a certain permeability effect can be maintained.

Please refer to FIG. 48B and FIG. 45, in this embodiment, the vertical distance HI between adjacent first vents 130T and the vertical distance H2 between adjacent second vents 240T are less than or equal to a vertical distance H3 between adjacent third vents 260T. In addition, the transverse distance D1 between adjacent first vents 130T and the transverse distance D2 between adjacent second vents 240T are both smaller than a transverse distance D3 of the third vent 260T. A distribution density of the third vents 260T in the third vent region 270T may be less than or equal to the distribution density of the second vents 240T in the second vent region 250T and less than or equal to the distribution density of the first vents 130T in the first vent region 140T.

It should be noted that because there is the gap between the front cover 210T and the rear cover 220T of the backrest portion 200T, the purpose of the present disclosure can be achieved regardless of whether the first vent 130T and the third vent 260T are aligned back and forth or whether the second vent 240T and the third vent 260T are aligned back and forth.

In this embodiment, the vertical distance H3 between adjacent third vents 260T may be an integer multiple of the vertical distance H1 between adjacent first vents 130T (or the vertical distance H2 between adjacent second vents 240T), that is, H3=M*H1 (or H3=M*H2), where M is a positive integer greater than or equal to 1.

In addition, a transverse distance D3 between adjacent third vents 260T may be an integer multiple of the transverse distance D1 between adjacent first vents 130T or the transverse distance D2 between adjacent second vents 240T. In this way, when the headrest portion 100T is in different positions, at least a part of the first vents 130T or at least a part of the second vents 240T may be aligned with a part of the third vents 260T, which can provide better permeability effect.

Please refer to FIG. 49, in this embodiment, a height (vertical dimension) of the first vent region 140T may be smaller than a height of the second vent region 250T. In addition, when the headrest portion 100T is adjusted to the highest position, the first vent region 140T and the second vent region 250T are completely staggered in the vertical direction, and the first vents 130T are not communicated with the second vents 240T. Please refer to FIG. 45, the first vents 130T or the second vents 240T may still be directly communicated with the third vents 260T on the rear cover 220T to achieve the purpose of permeability, and the present disclosure is not limited to this. In other embodiments, when the headrest portion 100T is adjusted to the highest position, the first vent region 140T may partially overlap with the second vent region 250T, so that at least a part of the first vents 130T and a part of the second vents 240T may be aligned with each other.

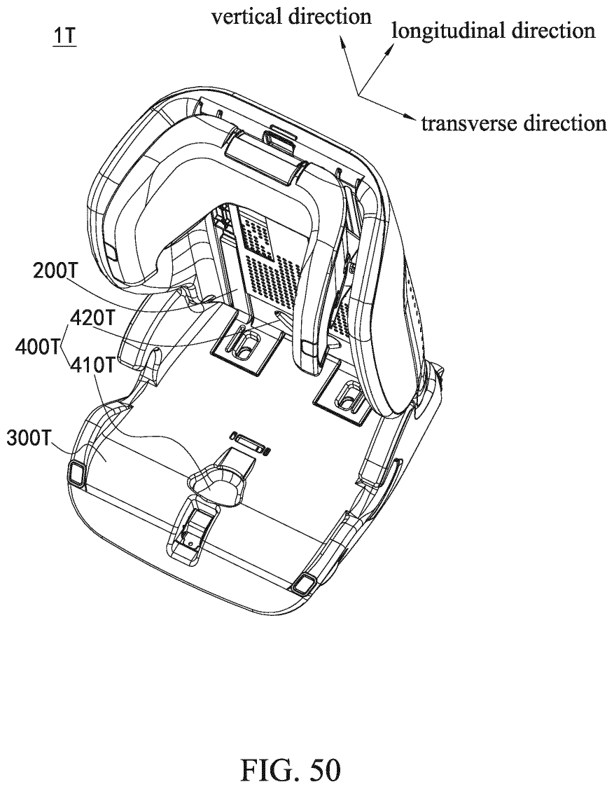

A buckle storage structure 400T of the child safety seat according to the present disclosure is described with reference to FIGS. 49 to 51.

The buckle storage structure 400T includes a first storage space 410T disposed in the seat portion 300T and a second storage space 420T disposed in the backrest portion 200T. One of the first storage space 410T and the second storage space 420T is used for storing a male buckle and the other is used for storing a female buckle. The male buckle and the female buckle may take any appropriate form known in the art and will not be described in detail herein. In this embodiment, the first storage space 410T is used to store the female buckle and the second storage space 420T is used to store the male buckle.

More specifically, the first storage space 410T is disposed at a transverse center of the seat portion 300T and close to the longitudinal front of the seat portion 300T, and the first storage space 410T is disposed as a concave portion depressed downward from an upper surface of the seat portion 300T, and an edge shape of the first storage space 410T corresponds to the female buckle. For example, the first storage space 410T may have a substantially trapezoidal shape with a wider front end and a narrower rear end. According to the shape of the female buckle, the first storage space 410T may take other appropriate shapes.

The second storage space 420T is disposed at a transverse center of the backrest portion 200T and close to the vertical lower part of the backrest portion 200T, and the second storage space 420T is disposed as a concave portion recessed backward from a front surface of the backrest portion 200T, and a contour of the second storage space 420T corresponds to the male buckle. For example, the second storage space 420T may have a general arrow shape with the head downward. According to the shape of the male buckle, the second storage space 420T may also have other appropriate shapes.

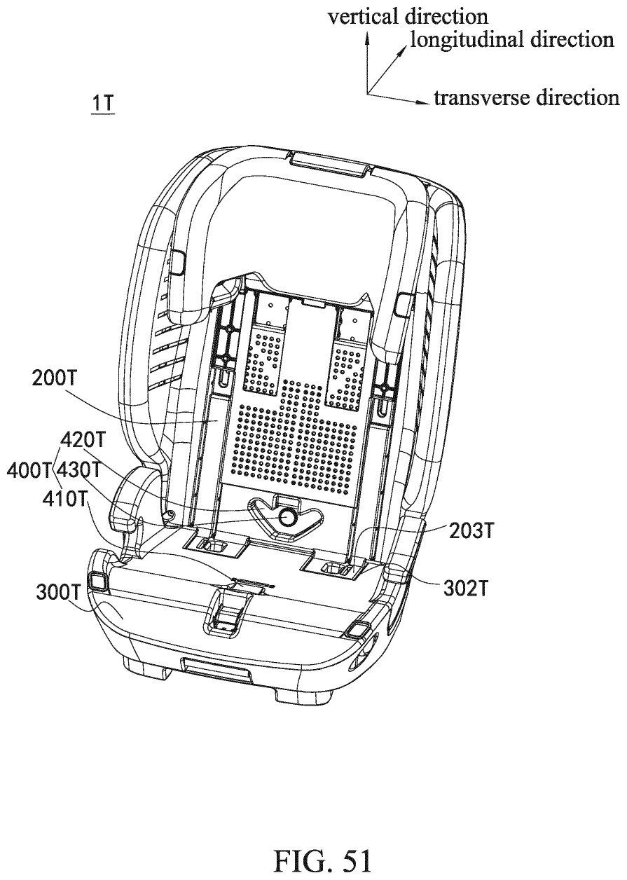

In one embodiment, the buckle storage structure 400T may further include an adsorbing element 430T (see FIG. 51). The adsorbing element is disposed on a bottom wall of the second storage space 420T, and can adsorb the male buckle and keep the male buckle in the second storage space 420T. For example, the adsorbing element 430T may be disposed at the transverse center of the second storage space 420T. In one embodiment, the adsorbing element 430T may be a magnetic adsorbing element, which can adsorb the male buckle made of metal.

In other embodiments, the shapes and functions of the first storage space 410T and the second storage space 420T may be interchanged. That is, the first storage space 410T may be used to store the male buckle and has a shape corresponding to the male buckle. The second storage space may be used for storing the female buckle and has a shape corresponding to the female buckle.

In one embodiment, a lower end of the backrest portion 200T is detachably connected to the longitudinal rear end of the seat portion 300T. Therefore, the backrest portion 200T and the seat portion 300T may be separated from each other. Since the male buckle and the female buckle are stored in the first storage space 410T of the seat portion 300T and the second storage space 420T of the backrest portion 200T respectively, the male buckle and the female buckle may be stored separately from each other.

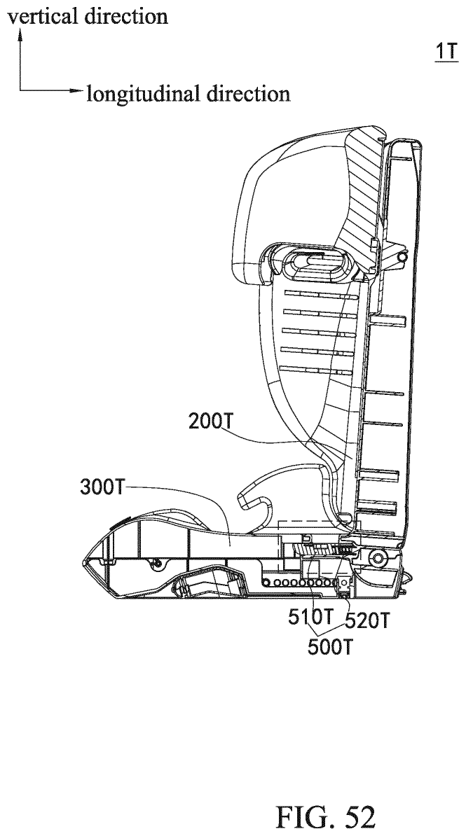

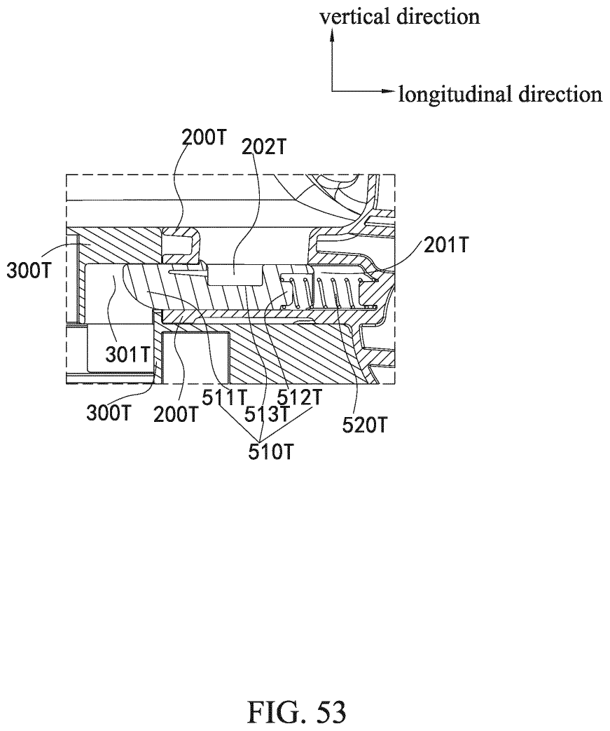

A backrest locking structure 500T of the child safety seat according to the present disclosure is described with reference to FIGS. 52 to 53.

The child safety seat of the present disclosure includes at least one backrest locking structure 500T, which is at least partially disposed in the backrest portion 200T, can connect the backrest portion 200T to the seat portion 300T, and can be operated from the exterior of the seat portion 300T to unlock a connection between the backrest portion 200T and the seat portion 300T.

As shown in FIG. 52, the backrest locking structure 500T includes a locking element 510T and a restoring element 520T. The locking element 510T can move between a locking position and an unlocking position. FIGS. 52 and 53 show the locking element 510T in the locking position. The locking element 510T moves from a position shown in FIGS. 52 and 53 to the longitudinal rear (the right in FIGS. 52 and 53) and reaches the unlocking position. When the locking element 510T is in the locking position, the locking element 510T at least partially extends out of the backrest portion 200T and can be inserted into a locking groove 301T of the seat portion 300T to connect the backrest portion 200T to the seat portion 300T. When the locking element 510T is in the unlocking position, the locking element 510T retracts into the backrest portion 200T and is disengaged from the locking groove 301T of the seat portion 300T.

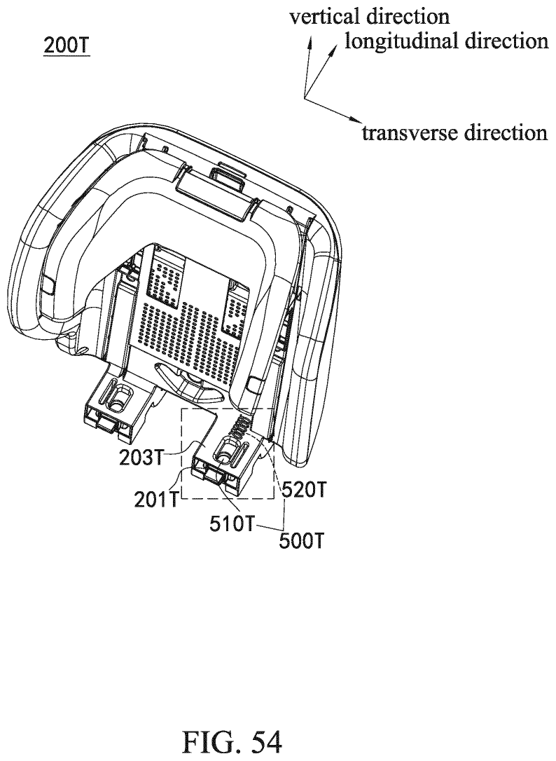

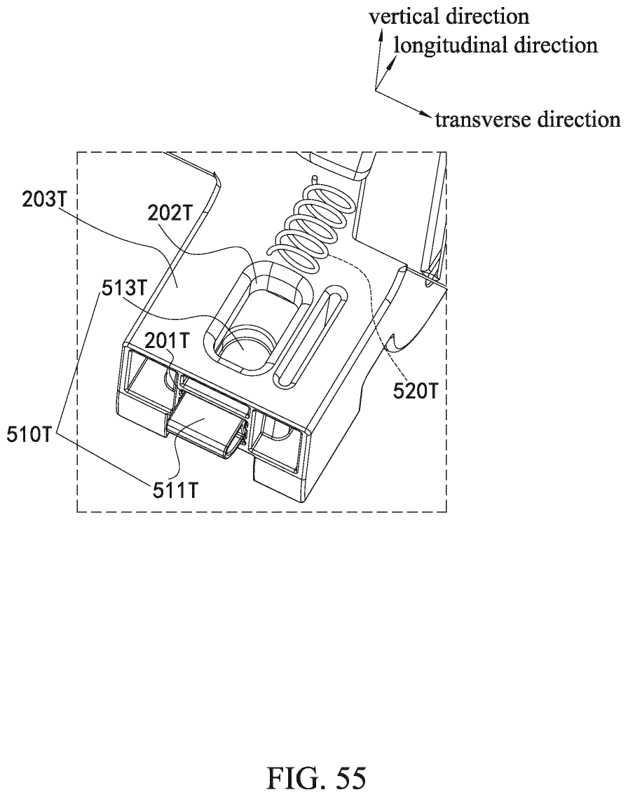

More specifically, the locking element 510T includes a first end 511T, a second end 512T and an operating element 513T. The first end 511T faces the outside of the backrest portion 200T (the front side in the longitudinal direction, i.e., a left side in FIGS. 52 and 53), and when the locking element 510T is in the locking position, the first end 511T extends out of the backrest portion 200T. The second end 512T is opposite to the first end 511T in the longitudinal direction and faces the inner side (the longitudinal rear side, i.e., a right side in FIGS. 52 and 53) of the backrest portion 200T, and the restoring element 520T abuts against the second end 512T. The operating element 513T is located between the first end 511T and the second end 512T, can be operated from the external of the backrest portion 200T, and is disposed to be butted by a finger to move the locking element 510T to the unlocking position. The operation section 513T will be described in more detail with reference to FIGS. 54 and 55.

As shown in FIGS. 52 and 53, the restoring element 520T is disposed between the locking element 510T and the backrest portion 200T, and biases the locking element 510T toward the locking position. More specifically, the restoring element 520T is accommodated in the sliding groove 201T disposed in the backrest portion 200T. Both ends of the restoring element 520T respectively abut against the second end 512T of the locking element 510T and the longitudinal rear end of the sliding groove 201T to bias the locking element 510T to the locking position.

The backrest locking structure 500T will be described with reference to FIGS. 54 and 55.

The backrest portion 200T includes at least one engagement portion 203T extending from a vertical lower end of the backrest portion 200T in a longitudinal direction, and the backrest locking structure 500T is disposed in the engagement portion 203T.

More specifically, the engagement portion 203T is substantially rectangular, and a sliding groove 201T is disposed therein (see also FIG. 53). The locking element 510T is slidably disposed in the sliding groove 201T. In FIGS. 54 and 55, the locking element 510T is in the locking position, and its first end 511T protrudes from the sliding groove 201T. The upper surface of the engagement portion 203T is provided with an opening 202T. The user may contact the operating element 513T of the locking element 510T through the opening 202T, thereby moving the operating element 513T backward in the longitudinal direction (upper right in FIGS. 54 and 55) to the unlocking position (not shown in the figure), so that the locking element 510T retracts into the engagement portion 203T.

As shown in FIG. 54, in this embodiment, the backrest portion 200T includes two engagement portions 203T arranged in parallel in the transverse direction, and each engagement portion 203T is provided with a backrest locking structure 500T to stably engage the backrest portion 200T to the seat portion 300T.

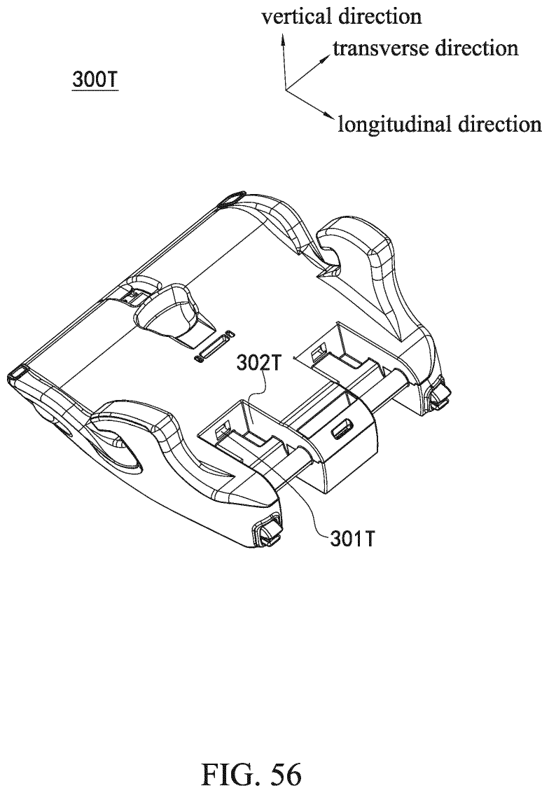

Referring to FIG. 56, a structure of the seat portion 300T related to the backrest locking structure 500T will be described.

The seat portion 300T includes at least one engagement groove 302T, which is disposed at the longitudinal rear end of the seat portion 300T. The shape, number, and position of the engagement groove 302T generally correspond to the shape, number, and position of the engagement portion 203T of the backrest portion 200T (referring to FIGS. 54 and 55). For example, when the engagement portion 203T is substantially rectangular, the engagement groove 302T is also substantially rectangular. A front wall of the engagement groove 302T is provided with a locking groove 301T, and a locking element 510T can be inserted into the locking groove 301T to engage the backrest portion 200T to the seat portion 300T.

In this embodiment, the backrest portion 200T is engaged to the seat portion 300T in the vertical direction, that is, the engagement portion 203T is inserted into the engagement groove 302T in the vertical direction. The locking element 510T is inserted into the locking groove 301T in the longitudinal direction, thus preventing a relative movement between the backrest portion 200T and the seat portion 300T in the vertical direction. In other embodiments, the locking element 510T may also be inserted into the locking groove 301T in other directions, for example, in the transverse direction, as long as the relative movement between the backrest portion 200T and the seat portion 300T in the vertical direction is prevented.

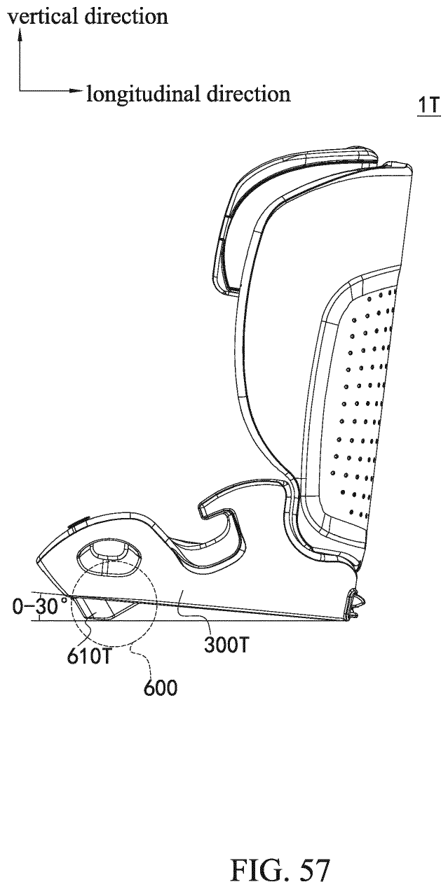

A seat angle adjusting structure 600T of the child safety seat according to the present disclosure is described with reference to FIGS. 57 to 60.

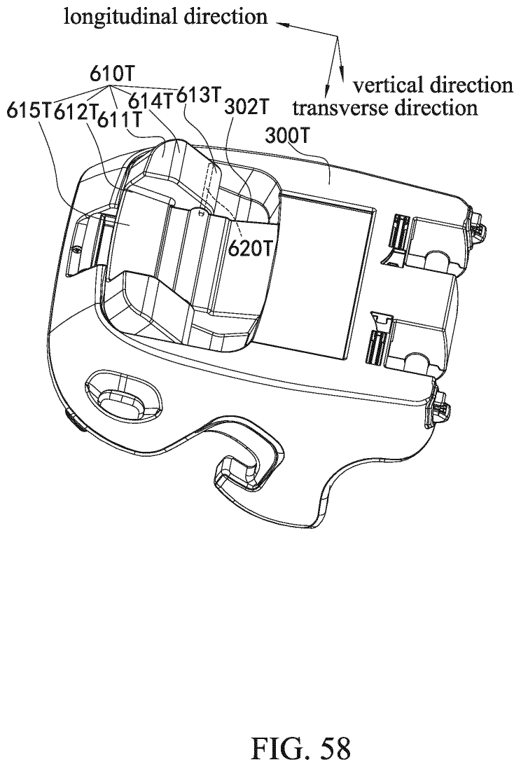

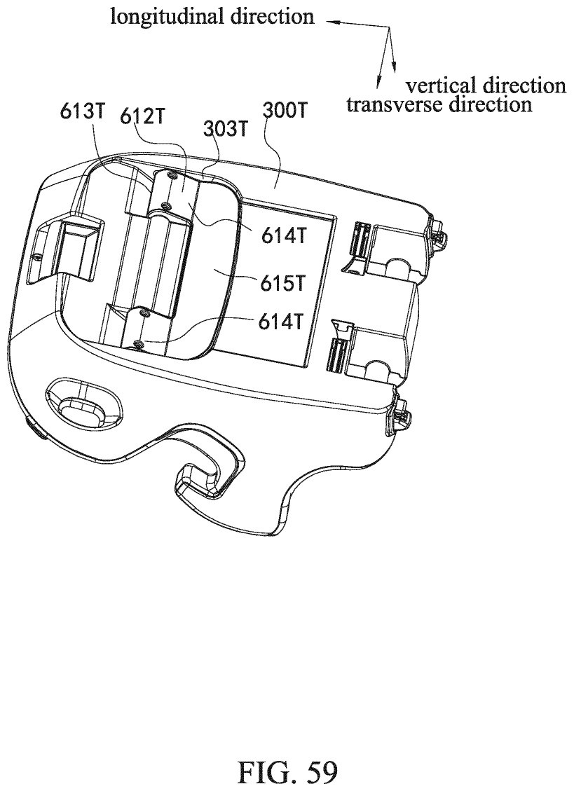

The seat angle adjusting structure 600T includes a supporting element 610T disposed on a bottom surface of the seat, and the supporting element 610T can move between an unfolded position (as shown in FIGS. 57 and 58) and a folded position (as shown in FIG. 59) relative to the seat portion 300T to adjust an angle of the seat portion 300T relative to a horizontal plane.

More specifically, a movement of the supporting element 610T between the unfolded position and the folded position is an overturning movement around a transverse axis, and the unfolded position of the supporting element 610T is closer to a longitudinal front of the seat portion 300T than the folded position. In other embodiments, the movement of the supporting element 610T between the unfolded position and the folded position may also be a movement around a longitudinal axis or an oblique axis, such as a sliding movement, a rotating movement or an overturning movement.

More specifically, as shown in FIGS. 58 and 59, the supporting element 610T includes two adjusting portions 614T and a connecting portion 615T. The two adjusting portions 614T are pivotally connected to the seat portion 300T, respectively, and the connecting portion 615T is connected between the two adjusting portions 614T in the transverse direction.

Each adjusting portion 614T includes at least one protruding surface 611T and at least one non-protruding surface 612T which are opposite to each other in the vertical direction. As shown in FIG. 58, when the supporting element 610T is in the unfolded position, the non-protruding surface 612T abuts against a bottom surface of the seat portion 300T, and the protruding surface 611T protrudes downward from the bottom surface of the seat portion 300T to raise a front end of the seat portion 300T. As shown in FIG. 59, when the supporting element 610T is in the folded position, the protruding surface 611T faces the seat portion 300T, while the non-protruding surface 612T does not protrude from the bottom surface of the seat portion 300T, and the supporting element 610T is folded into the seat portion 300T.

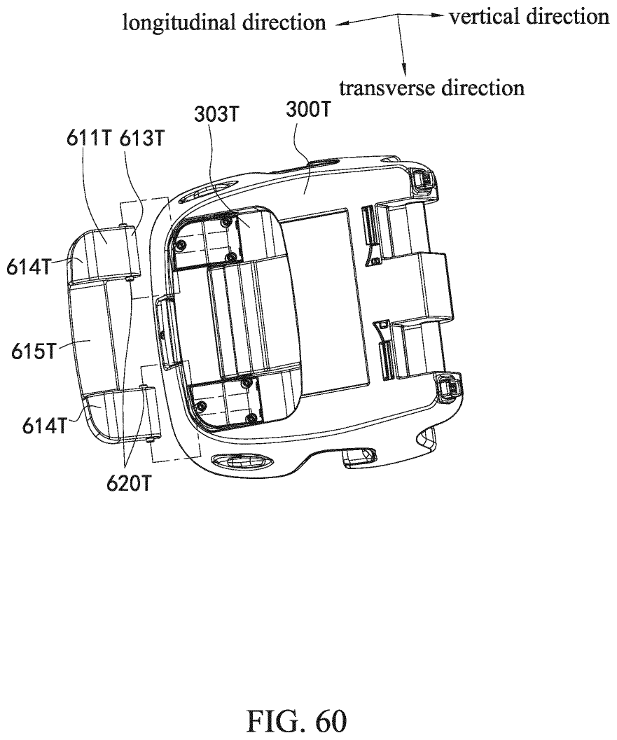

As shown in FIG. 60, a longitudinal end of each adjusting portion 614T is a pivot end 613T, and each pivot end 613T is pivotally connected to the accommodating portion 303T of the seat portion 300T through a rotating shaft 620T. The accommodating portion 303T may be a concave portion formed by the bottom of the seat portion 300T being depressed upward.

When the supporting element 610T is in the unfolded position and the folded position, the angle of the seat portion 300T relative to the horizontal plane varies from 0° to 30° (see FIG. 57). That is, when the supporting element 610T is in the unfolded position, the bottom surface of the seat portion 300T can be raised by 0° to 30° relative to the horizontal plane.

Those skilled in the art will easily think of other embodiments of the present disclosure after considering the specification and practicing the present disclosure as mentioned above. The present disclosure is intended to cover any variations, uses or adaptations of the present disclosure, which follow the general principles of the present disclosure and include common knowledge or common technical means in the technical field that are not disclosed in the present disclosure. Also, the specification and its embodiments are to be regarded as examples only, and the scope and spirit of the present disclosure are indicated by the claims of the present disclosure.

Although the present disclosure has been described with reference to the examples of typical embodiments, the terms used are illustrative and exemplary, rather than restrictive. Since the present disclosure may be embodied in various forms without departing from the spirit and essence of the present disclosure, it should be understood that the above-mentioned embodiments are not limited to any of the foregoing details, but should be interpreted in the broadest sense within the scope defined by the claims, so all changes that fall within the scope of the claims or their equivalents should be covered by the claims.

1-20. (canceled)

21. A child safety seat comprising:
a headrest portion, provided with a first groove for a safety belt to pass through; and
a backrest portion, wherein the headrest portion is slidably connected to the backrest portion, so that the headrest portion is capable of being adjusted to different positions relative to the backrest portion,
wherein, the backrest portion is provided with a first turning portion which is disposed on the backrest portion, and the safety belt bypasses the first turning portion and extends out from a front side of the child safety seat through the first groove,
wherein the headrest portion is movable between a first position and a second position relative to the backrest portion, and the first turning portion is located in a height adjustment stroke of the headrest portion relative to the backrest portion, and
when the first groove is lower than the first turning portion, the safety belt passing through the first groove allows adjustment of the position of the headrest portion, and when the first groove is not lower than the first turning portion, the safety belt passing through the first groove limits a further upward adjustment of the headrest portion relative to the backrest portion.

22. (canceled)

23. The child safety seat according to claim 21, wherein the height adjustment stroke is a moving range of a lower edge of a body of the headrest portion when the headrest portion moves from the first position to the second position.

24. The child safety seat according to claim 23, wherein the headrest portion is configured such that: when the headrest portion is in the first position, a vertical height of a lower edge of the first groove is higher than the first turning portion, and when the headrest portion is in the second position, the vertical height of the lower edge of the first groove is lower than the first turning portion.

25. The child safety seat according to claim 23, wherein the length of the first groove is smaller than a distance between the first position and the second position.

26. The child safety seat according to claim 23, wherein the backrest portion is provided with a second groove for the safety belt to pass through, and the first turning portion coincides with the second groove in a vertical direction.

27. The child safety seat according to claim 26, wherein the headrest portion is configured such that: at least a part of the first groove coincides with the second groove when the headrest portion slides within the height adjustment stroke of the headrest portion relative to the backrest portion.

28. The child safety seat according to claim 23, wherein the backrest portion is formed with a buckle storage space for storing a male buckle, wherein the headrest portion shields at least a part of the buckle storage space when the headrest portion is in the first position, and the headrest portion does not shield the buckle storage space when the headrest portion is in the second position.

29. The child safety seat according to claim 28, wherein the buckle storage space is provided with a magnetic buckle for adsorbing a buckle.

30. (canceled)

31. The child safety seat according to claim 21, wherein the child safety seat is further provided with a second turning portion, which is disposed at a rear part of a seat portion of the child safety seat, and the safety belt is configured to bypass the second turning portion and the first turning portion and pass through the first groove to the front side of the child safety seat.

32-37. (canceled)

38. The child safety seat according to claim 21, wherein:
the headrest portion comprises a board portion, wherein the board portion is provided with a first vent region, and the first vent region comprises a first vent; and
the backrest portion is provided with a second vent region, and the second vent region comprises a second vent;
wherein when the first vent region at least partially overlaps with the second vent region, the first vent is communicated with the second vent, wherein
the board portion is slidable along a path relative to the backrest portion, and the board portion is capable of being held in at least one position in the path; and
at a position where the first vent region at least partially overlaps with the second vent region, at least one first vent is communicated with at least one second vent, and when the board portion is located at the position where the first vent region at least partially overlaps with the second vent region, an overlapping area between the first vent and the second vent is at least 20% of an area of the board portion.

39-44. (canceled)

45. The child safety seat according to claim 38, wherein the headrest portion comprises a buffer portion connected to the board portion, wherein the first vent region is closer to an end of the board portion away from the buffer portion, and a distribution density of the first vent in a range of the first vent region is greater than or equal to a distribution density of the second vent in a range of the second vent region, and
the board portion is slidable along the path relative to the backrest portion, and the board portion is capable of being held in the at least one position in the path, wherein a moving stroke of the board portion between two adjacent positions is an integer multiple of a vertical distance between two adjacent second vents.

46. (canceled)

47. The child safety seat according to claim 38, wherein the backrest portion comprises:
a front cover, provided with the second vent; and
a rear cover, attached to a longitudinal rear of the front cover, wherein the rear cover is provided with a third vent region, and a third vent is disposed in the third vent region,
wherein the third vent region is divided into a middle region corresponding to the front cover and surrounding regions respectively located at both sides of the middle region, and a distribution density of the third vent in the middle region is less than or equal to a distribution density of the third vent in either of the surrounding regions.

48. The child safety seat according to claim 38, wherein the backrest portion comprises:
a front cover, provided with the second vent; and
a rear cover, attached to a longitudinal rear of the front cover, wherein the rear cover is provided with a third vent region, and a third vent is disposed in the third vent region, at least one of the second vent and the first vent is communicated with the third vent, and a vertical distance between adjacent third vents is an integer multiple of a vertical distance between adjacent first vents, or an integer multiple of a vertical distance between adjacent second vents.

49. The child safety seat according to claim 21, wherein the child safety seat comprises:
a seat portion, wherein the backrest portion is connected to the seat portion; and
a buckle storage structure, disposed in the seat portion and the backrest portion, wherein the buckle storage structure comprises:
a first storage space, disposed in the seat portion; and
a second storage space, disposed in the backrest portion,
wherein the first storage space is disposed at a transverse center of the seat portion and close to a longitudinal front of the seat portion, and the first storage space is disposed as a concave portion depressed downward from an upper surface of the seat portion, and an edge shape of the first storage space corresponds to the female buckle,
the second storage space is disposed at a transverse center of the backrest portion and close to a vertical lower part of the backrest portion, the second storage space is arranged as a concave portion depressed backward from a front surface of the backrest portion, and an edge shape of the second storage space corresponds to the male buckle,
wherein the buckle storage structure further comprises an adsorbing element, disposed on a bottom wall of the second storage space, wherein the adsorbing element is capable of adsorbing the male buckle, so that the male buckle is kept in the second storage space.

50-52. (canceled)

53. The child safety seat according to claim 49, wherein the backrest portion comprises:
at least one backrest locking structure, wherein the backrest portion is connected to the seat portion via the at least one backrest locking structure, and the at least one backrest locking structure is operable from an exterior of the seat portion to unlock a connection between the backrest portion and the seat portion, and wherein the backrest locking structure comprises:
a locking element, movable between a locking position and an unlocking position, wherein when the locking element is in the locking position, the locking element at least partially extends out of the backrest portion and is capable of being inserted into the seat portion to connect the backrest portion to the seat portion, and when the locking element is in the unlocking position, the locking element retracts into the backrest portion and is separated from the seat portion; and
a restoring element, configured to bias the locking element toward the locking position.

54. The child safety seat according to claim 53, wherein the locking element comprises:
a first end, facing an outside of the backrest portion, wherein the first end extends out of the backrest portion when the locking element is in the locking position;
a second end, opposite to the first end in a longitudinal direction and facing an inner side of the backrest portion, wherein the restoring element abuts against the second end; and
an operating portion, located between the first end and the second end, wherein the operating portion is operable from an external of the backrest portion, and the operating portion is disposed to be butted by a finger to move the locking element to the unlocking position.

55. The child safety seat according to claim 53, wherein:
the backrest portion comprises at least one engagement portion extending from a vertical lower end of the backrest portion in a longitudinal direction, and the backrest locking structure is disposed in the engagement portion; and
the seat portion comprises at least one engagement groove, which is disposed at a longitudinal rear end of the seat portion, wherein a locking groove is disposed at a front wall of the engagement groove, and the locking element is capable of being inserted into the locking groove, to engage the backrest portion to the seat portion.

56. The child safety seat according to claim 55, wherein:
the backrest portion is vertically engaged to the seat portion, and the locking element is disposed to be engaged to the locking groove to prevent a relative movement between the backrest portion and the seat portion in the vertical direction.

57. The child safety seat according to claim 21, wherein the child safety seat further comprises:
a seat portion; and
a seat angle adjusting structure, comprising a supporting element disposed on a bottom surface of the seat portion, wherein the supporting element is movable between an unfolded position and a folded position relative to the seat portion to adjust an angle of the seat portion relative to a horizontal plane,
wherein a movement of the supporting element between the unfolded position and the folded position is an overturning movement around a transverse axis, and the unfolded position of the supporting element is closer to a longitudinal front of the seat portion than the folded position.

58. The child safety seat according to claim 57, wherein the supporting element comprises:
two adjusting portions, pivotally connected to the seat portion respectively; and
a connecting portion, connected between the two adjusting portions in a transverse direction,
wherein each adjusting portion comprises at least one protruding surface and at least one non-protruding surface which are opposite to each other in a vertical direction; and
when the supporting element is in the unfolded position, the non-protruding surface abuts against a bottom surface of the seat portion, and the protruding surface protrudes downward from the bottom surface of the seat portion to raise a front end of the seat portion, and when the supporting element is in the folded position, the supporting element is folded into the seat portion.

59-60. (canceled)
